(19) United States
(12) Patent Application Publication
(10) Pub. No.: US 2026/0340370 A1
(43) Pub. Date: Oct. 29, 2026

(54) POWER CONFIGURATION TECHNIQUES AND CIRCUITRY FOR NEURAL NETWORKS

(71) Applicant: Openchip & Software Technologies S.L., Barcelona (ES)

(72) Inventors: Tommaso Vali, Sezze (LT) (IT); Francesc Guim Bernat, Barcelona (ES); Cristina Lattaro, Rieti (IT); Carmelo Condemi, San Giovanni (IT); Mattia Chichocki, Roma (IT); Umberto Siciliani, Rubano (IT); Shashidhar Krishnamurthy, Barcelona (ES)

(21) Appl. No.: 19/634,490

(22) Filed: Mar. 31, 2026

Related U.S. Application Data
(63) Continuation of application No. PCT/EP2025/077033, filed on Sep. 22, 2025.

(51) Int. Cl. G06N 3/063; G06F 7/544; G06N 3/048; G06N 3/0495

(52) U.S. Cl. CPC G06N 3/063; G06F 7/5443; G06N 3/048; G06N 3/0495

(57) ABSTRACT

Aspects of neural network (NN) power configuration are discussed. Processing circuitry is disclosed, comprising compute circuitry with hardware resources to perform compute operations of a neural network configured in a computing platform, and neural network management circuitry. The neural network management circuitry is to receive a configuration parameter associated with a workload of the neural network, selectively activate or deactivate a subset of the hardware resources of the compute circuitry based on the configuration parameter, configure the compute circuitry to operate in a first resolution mode by enabling a first subset of the hardware resources to perform a coarse classification task, configure the compute circuitry to operate in a second resolution mode to perform a fine classification task based on completion of the coarse classification task, and control transitions between the first resolution mode and the second resolution mode based on a completion status of the workload.

### PRIORITY

This application is a continuation of International Application No. PCT/EP2025/077033, filed Sep. 22, 2025, which is incorporated by reference herein in its entirety.

### STATEMENT OF FUNDING

This invention was made with government support under Grant UNICO-IPCEI-2023-001 funded by the European Union-Next Generation EU, Important Projects of Common European Interest (IPCEI).

### BACKGROUND

Current computing systems are often composed of large deployments of different hardware arrangements of different sizes, such as hardware in a 1U rack unit, half a rack, or multiple racks. These deployments potentially host different types of platforms and computing technologies, including different processor models, different accelerators, and different routing architectures. Additionally, a large number of software applications and uses—such as databases, video analytics, and content delivery—are being developed by different companies. These applications exhibit different behaviors and utilize system resources in different ways. For example, some software applications may be more I/O centric, while others may be compute-centric, and even different types of workloads with the same software application may have different effects on the processing hardware.

This diversity in hardware and software configurations presents a significant challenge for system telemetry, including mechanisms to monitor and validate potential service-level agreements (SLAs) associated with the provided functions. In particular, neural network workloads executed on such heterogeneous platforms can vary widely in their resource requirements, with some tasks demanding high compute throughput and others being limited by memory or I/O bandwidth. Traditional power and performance management techniques and circuitry are often implemented at the software level and do not provide fine-grained control over hardware resource utilization by neural network processing resources. Without such control mechanisms, power-efficient AI execution remains constrained by the limitations of existing software-centric adaptation strategies and the complexity of computing environments.

### BRIEF DESCRIPTION OF THE DRAWINGS

In the drawings, which are not necessarily drawn to scale, reference numerals are repeated to describe similar components in different views. Like numerals having different letter suffixes may represent different instances of similar components. The drawings illustrate generally, by way of example, but not by way of limitation, various embodiments discussed in the present document.

FIG. 1 depicts an architecture of a computing system having processor circuitry usable with the present power configuration techniques and circuitry, according to an embodiment.

FIG. 2 depicts implementation details regarding a neural network (NN) manageability engine, according to an embodiment.

FIG. 3 depicts an example NN with multiple layers, according to an embodiment.

FIG. 4 depicts NN circuitry configured to process data and identify classes and sub-classes at a full resolution, according to an embodiment.

FIG. 5 depicts an example image set separated by classes and sub-classes, which can be used in connection with the disclosed techniques and circuitry, according to an embodiment.

FIG. 6 depicts the equivalence between an example NN with multiple layers (e.g., NN 300) and NN circuitry (e.g., NN circuitry 400).

FIG. 7 depicts an example image set separated by classes and sub-classes that can be selected based on a hardware configuration, according to an embodiment.

FIG. 8 depicts NN circuitry configured to process data and identify classes and sub-classes at different resolutions and using different hardware configurations for a full set of processing hardware, according to an embodiment.

FIG. 9 depicts NN circuitry configured to process data and identify classes and sub-classes at different resolutions and using different hardware configurations for a reduced set of processing hardware, according to an embodiment.

FIG. 10 depicts an example of basic building blocks of a multiplication-addition circuitry (MAC), which can be used in connection with the NN circuitry of FIG. 8 or FIG. 9, according to an embodiment.

FIG. 11 illustrates graphs of power consumption for the NN circuitries of FIG. 4, FIG. 8, and FIG. 9, according to an embodiment.

FIG. 12 depicts a method for NN power configuration, according to an embodiment.

FIG. 13 depicts a hardware arrangement of a data center used to provide multiple implementations or instances of a computing system, according to an example.

FIGS. 14A and 14B depict arrangements of a chip assembly with expanded views of the chiplets and processing units, according to an example.

FIG. 15 depicts a block diagram of a computing system, according to an example.

### DETAILED DESCRIPTION

The present disclosure relates generally to techniques and circuitry for configuring hardware in neural network (NN) systems, particularly to methods and systems for dynamically adjusting hardware configurations to optimize power consumption and performance. The disclosed approaches address challenges in managing power efficiency and computational precision in neural networks by introducing configurable hardware mechanisms that enable ultra-low power modes, automatic wake-up features, and dynamic resolution switching. These techniques and circuitry are applicable across a wide range of computing environments, including but not limited to data centers, edge devices, and Internet of Things (IoT) systems.

The embodiments described herein are provided as illustrative examples and are not intended to limit the scope of the described subject matter. Specific details, such as standard neural network operations, hardware components, and well-understood computational processes, may be omitted for clarity and brevity. Those skilled in the art will understand that various modifications, rearrangements, and substitutions of components or steps may be made without departing from the spirit and scope of the subject matter as defined by the claims.

As used herein, the term “neural network” (or NN) indicates a computational model composed of interconnected nodes (neurons) organized in layers, which processes input data by applying weights and activation functions to perform tasks such as classification, regression, or pattern recognition.

As used herein, the term “hardware manageability circuitry” indicates specialized hardware components, such as a neural network (NN) manageability engine, configured to monitor, control, and adjust the operational parameters of processing hardware, including power configuration and telemetry management.

As used herein, the term “MAC” (multiplication-addition circuit) indicates a hardware circuit that performs multiplication and accumulation operations, typically comprising at least one multiplier circuit and at least one adder circuit, and can be used to implement the core computations of a neural network.

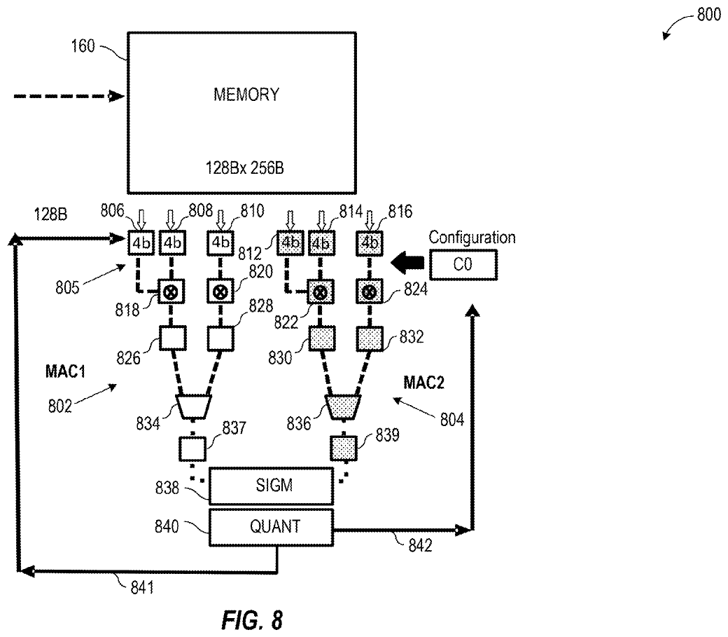

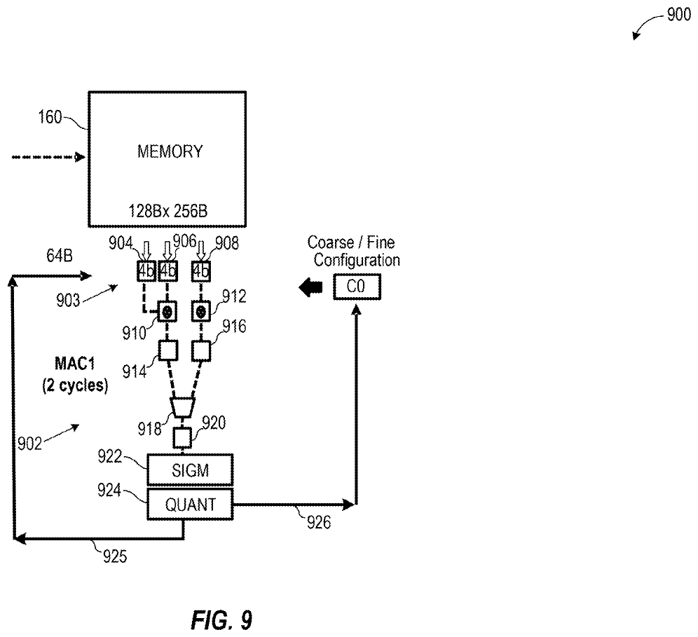

As used herein, the term “gross resolution” (or “coarse resolution”) indicates a mode of neural network operation during which basic or coarse classification tasks are performed. In some aspects, gross resolution operation can be performed with a subset of the available hardware resources or lower bit-widths (e.g., integer-4 or INT4), enabling the neural network to operate with reduced power consumption and at a lower level of detail. Gross resolution is typically used for initial scanning or broad analysis to identify general patterns or areas of interest within the data geometry. As used herein, the term “fine resolution” indicates a mode of neural network operation during which the system performs high-precision or detailed classification tasks, often after a gross or intermediate resolution phase has identified a region or feature of interest. Fine resolution processing may utilize the full set of hardware resources (e.g., integer-8 or INT8), enabling all circuits and resulting in higher power consumption. In some aspects, the same full resolution (i.e., INT8 Bit) can be obtained if the circuit is designed (as in FIG. 8) by activating simultaneously the gross and fine resolution circuits. In this regard, this processing allows for using the gross/coarse processing only at lower power consumption, and activating gross and fine only when needed by the NN performance or processing requirements. Alternatively, a circuit can be designed as illustrated in FIG. 9, where only one instance of the circuit is present. In this configuration, the circuit can be used at gross resolution (Int4), and a second round of calculation (Int4) can be activated to mimic the Int8 full resolution processing. In this case, the circuit uses more time to perform the full resolution calculation, but saves at least one-half of the physical circuit area due to the reduced component count. Fine resolution may be achieved by executing additional calculations in parallel or in sequence with gross or intermediate processing, as illustrated in FIG. 8 and FIG. 9, to deliver the highest available level of detail for the data geometry under analysis.

As used herein, the term “appropriate resolution” indicates any mode of neural network operation that is selected to match the required level of detail or granularity for a given task or data geometry. Appropriate resolution may include one or more intermediate resolution modes that fall between gross and fine resolution, and may be defined by the use of a particular subset of hardware resources, bit-widths, or processing cycles. For example, an intermediate or appropriate resolution mode may use more resources or higher bit-widths than gross resolution, but fewer than fine resolution, to provide a balance between power consumption and analytical detail. Multiple sub-levels of resolution or granularity may be defined as appropriate resolution modes, allowing the system to dynamically adapt to the complexity or importance of the data being processed. This flexible approach supports the use of more than two operational modes, enabling the neural network to efficiently allocate resources and power across a spectrum of resolution levels as needed.

As used herein, the term “ultra-low power mode” indicates a hardware configuration in which certain circuits or subcomponents are powered down or disconnected from the power supply, resulting in reduced power consumption while maintaining limited or essential functionality. In this regard, a compute platform can operate in an ultra-low power mode when performing coarse resolution processing and fine resolution processing using a subset of the available hardware resources.

As used herein, the term “automatic wake-up” indicates a feature or mechanism by which the system transitions from a low-power or coarse resolution mode to a fine resolution mode in response to specific triggers or feedback, which may include but are not limited to signals from the neural network (such as the detection of a particular class), telemetry data, external commands, or other system events.

As used herein, the term “configuration knob” indicates a controllable parameter or register (such as a model-specific register, system control register, or control and status register) that can be adjusted by management software, neural network manageability circuitry, or other authorized system components to modify the operational characteristics of hardware components, including power, performance, and resolution settings.

As used herein, the term “telemetry” indicates the collection, transmission, and analysis of data obtained from various points within a system, such as sensors, monitors, or hardware registers, relating to the operational state, performance, and environmental conditions of hardware components. Telemetry may be gathered using mechanisms including, for example, on-chip sensors, software agents, hardware monitors, or dedicated telemetry management circuitry, and can be used for monitoring, diagnostics, and dynamic configuration.

As used herein, the term “chiplet” indicates any integrated circuit (IC) designed to perform one or more specific functions in a modular structure including interface circuitry to connect the chiplet to an interposer or other interconnect structure to permit communication between the chiplet and one or more other chiplets via one or more standardized protocols to form a system. Unlike monolithic systems implemented with different circuitry types on a single substrate, such as some general-purpose microprocessors, systems implemented with chiplets are modular and may include chiplets from one manufacturer or multiple different manufacturers. Applicable configurations of chiplets in circuitry include separate chiplets (e.g., independent or isolated from one another), sets of the same or similar homogeneous chiplets (e.g., in a coordinated or organized grouping that shares resources with each other), or sets of different heterogeneous chiplets (e.g., in a partially-coordinated or partially-organized grouping that communicates with each other such as with a protocol and interconnect). Any of these configurations of chiplets may be installed, deployed, or packaged on the same physical structure (e.g., a common substrate or package).

As used herein, the term “Universal Chiplet Interconnect Express (UCIe)” indicates a standardized interface protocol and physical interconnect used to enable communication and interoperability between chiplets within a multi-chiplet package.

As used herein, the term “AI artifact” indicates any output or intermediate data generated during the development, training, deployment, or use of a neural network model, including but not limited to weights, predictions, gradients, or transformed data sets.

As used herein, the term “management software stack” indicates a collection of software components, including telemetry, power management, and control modules, that operate on one or more compute platforms to monitor hardware state, collect telemetry data, and issue configuration commands.

As used herein, the term “visible configuration register” indicates a hardware register whose settings are accessible and modifiable by management software, the NN manageability engine, or other code, firmware, or software, allowing for dynamic adjustment of hardware parameters.

As used herein, the term “hidden configuration register” indicates a hardware register whose settings are not directly accessible or discoverable by management software (or other software), but which may influence the operation of hardware components.

As used herein, the term “telemetry management circuitry” indicates hardware components configured to detect communication flows, retrieve telemetry configurations, execute traces on metrics, and perform actions based on telemetry results to optimize system operation.

As used herein, the term “full-power mode” indicates a hardware configuration in which all device circuits and subcomponents are fully powered and operational, enabling maximum computational throughput and precision. This mode is typically used during fine resolution processing or when the highest level of performance is required for critical tasks.

As used herein, the term “low-power mode” indicates a hardware configuration in which selected circuits or subcomponents are powered down, disabled, or operated at reduced voltage or frequency, resulting in lower energy consumption while maintaining sufficient functionality for basic or intermediate processing tasks. Low-power mode may be used during coarse or intermediate resolution analysis, or when the system is monitoring for general patterns or events.

As used herein, the term “ultra-low power mode” indicates a hardware configuration in which only essential circuits remain active, with most processing elements powered down or disconnected from the power supply. This mode is used for minimal monitoring, standby, or background scanning, and is suitable for scenarios where energy conservation is paramount, such as battery-powered or remote devices.

As used herein, the term “suspended mode” indicates a hardware configuration in which the device or subsystem is placed in a near-zero power state, with all processing halted and only minimal circuitry (such as wake-up logic or persistent memory) remaining active to support rapid resumption of operation. Suspended mode may be used during periods of inactivity or when the system is awaiting a specific trigger to resume processing.

As used herein, the term “data geometry” indicates the structural or organizational characteristics of a data set or data stream, including but not limited to its type, format, dimensionality, or segmentation. A data geometry can encompass different types of data—such as images, audio, sensor readings, time-series, or network traffic—that may be segregated or partitioned according to varying levels of granularity or resolution. For example, a data geometry may refer to the spatial arrangement of pixels in an image, the temporal segmentation of a time-series, the hierarchical structure of text, or the partitioning of network flows. By defining and recognizing different data geometries, the system can apply the disclosed operational modes (such as coarse, intermediate, or fine resolution) to process data at the appropriate level of detail, enabling efficient and adaptive analysis tailored to the specific structure and requirements of each data set or stream.

Some NN implementations typically operate at a fixed resolution, such as INT8, to achieve high precision in classification and inference tasks. While effective for accuracy, this approach can result in substantial power consumption, as the full computational hardware is engaged at all times, regardless of the workload's complexity or the precision required. Furthermore, some NN configuration techniques and circuitry can rely on software-based methods to adjust resolution or the power settings dynamically. These methods, while offering some flexibility, fail to address the underlying inefficiencies at the hardware level, as they do not physically reconfigure the circuitry to optimize power usage. As a result, existing NN systems lack the ability to achieve ultra-low power operation while maintaining the capability to dynamically adapt to varying computational demands.

The disclosed techniques and circuitry address these challenges by incorporating hardware configurations for NNs that leverage feedback from the NN itself to dynamically adjust its operational state. Specifically, the disclosed techniques and circuitry enable the neural network to operate in a gross (or coarse) resolution mode (FIG. 8), utilizing a reduced subset of hardware resources (e.g., resources operating at INT4 resolution) for performing classification tasks, thereby reducing power consumption. Upon detecting specific triggers, such as the identification of a particular class or another trigger condition, the system can automatically transition to a fine resolution mode, activating additional hardware resources to perform high-precision classification tasks (e.g., to detect a sub-class within a detected class). This dynamic switching mechanism is achieved through specialized hardware manageability circuitry (e.g., NN manageability engine) that configures NN circuits such as multiplication-addition circuits (MACs) and control registers, which allow for selective activation and deactivation of computational components as well as reconfiguration of computational components (e.g., activating and using sub-registers within a register).

In addition to the coarse and fine resolution modes described in the disclosure, other embodiments may implement more than two resolution modes to provide greater flexibility and adaptability in neural network processing. For example, a system may include an intermediate resolution mode, resulting in three distinct modes: coarse, intermediate, and fine. In such an embodiment, the neural network management circuitry can selectively activate hardware resources to operate at a level of granularity that is tailored to the complexity or importance of the data being processed.

As an example, consider a system analyzing environmental sensor data for early detection of hazardous conditions. The system may operate in a coarse mode to scan for general anomalies in temperature, humidity, or air quality across a large geographic area. Upon detecting a deviation from baseline conditions, the system may transition to an intermediate mode, activating additional hardware resources to focus on a subset of sensors or a specific region, performing more detailed analysis such as trend detection or correlation across multiple sensor types. If the intermediate analysis indicates a potential hazard, the system can then enter a fine resolution mode, enabling full computational resources to perform high-precision modeling, predictive analytics, or real-time alert generation for the affected area.

In another embodiment, a financial analytics platform may utilize more than three resolution modes to process high-frequency trading data. The system could begin in a coarse mode, monitoring broad market indicators for unusual activity. If a pattern resembling a known market event is detected, the system may shift to a first intermediate mode, analyzing specific asset classes or time windows with moderate granularity. A second intermediate mode could be used to further narrow the focus, examining individual trades or order book movements with increased detail. Finally, the system may enter a fine resolution mode to perform in-depth risk assessment, scenario simulation, or compliance checks on the most relevant data segments.

Similarly, in the context of medical imaging, a neural network may process large volumes of scan data using multiple resolution modes. The system could start with a coarse mode to identify regions of interest in a set of MRI images. An intermediate mode may then be used to analyze tissue boundaries or detect subtle changes in texture within those regions. If a potential abnormality is found, the system can transition to a fine mode, applying advanced image segmentation and diagnostic algorithms to the specific area, supporting clinical decision-making with the highest available precision.

These embodiments demonstrate that the disclosed techniques and circuitry are not limited to binary resolution switching, but can be extended to support multiple levels of granularity. By enabling dynamic transitions among several resolution modes, the system can optimize resource utilization and power consumption while maintaining the ability to perform detailed analysis when warranted by the data or operational context.

By physically reconfiguring the hardware based on real-time feedback from the neural network, the described system achieves a level of power efficiency that can surpass software-only-based approaches. In some aspects, the disclosed techniques and circuitry can be used to configure NN circuits to operate in an ultra-low power mode, where certain circuits are entirely powered down or disconnected, resulting in a significant reduction in energy consumption. While in ultra-low power mode, the NN circuits perform both coarse and fine resolution processing with a reduced set of circuitry (e.g., using INT4 sub-registers instead of INT8 full registers), thereby increasing the power efficiency.

The disclosed techniques and circuitry also provide for an automatic wake-up feature, enabling seamless transitions between coarse and fine resolution modes without manual intervention. This approach not only optimizes power usage but also enhances the NN system's flexibility and responsiveness, making the design suitable for a wide range of applications, from data centers to edge devices and IoT systems.

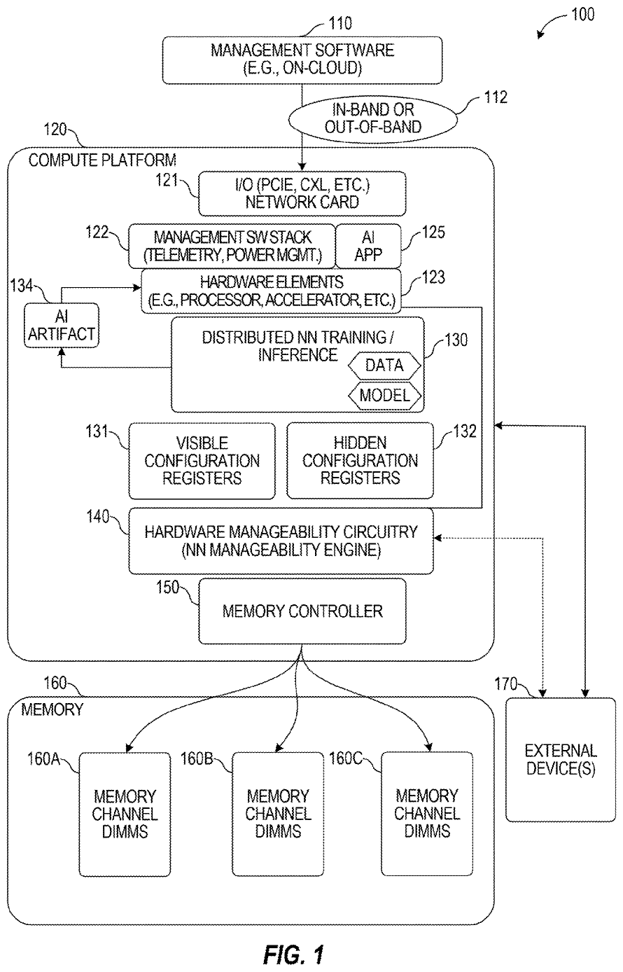

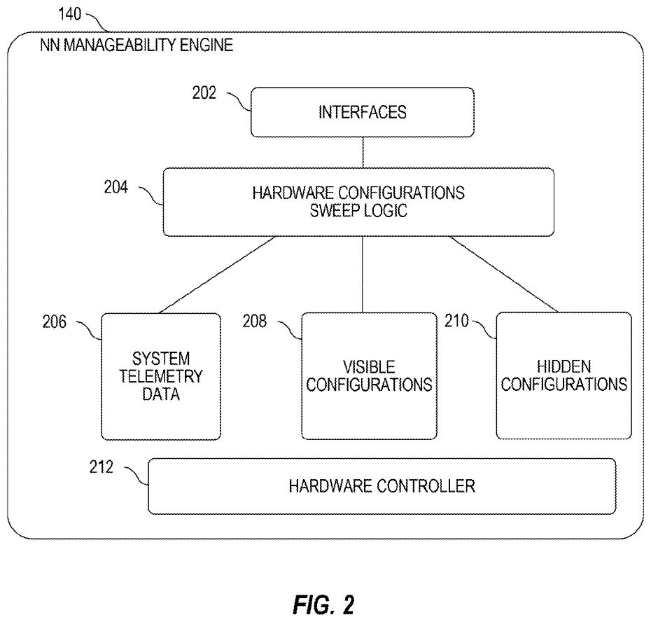

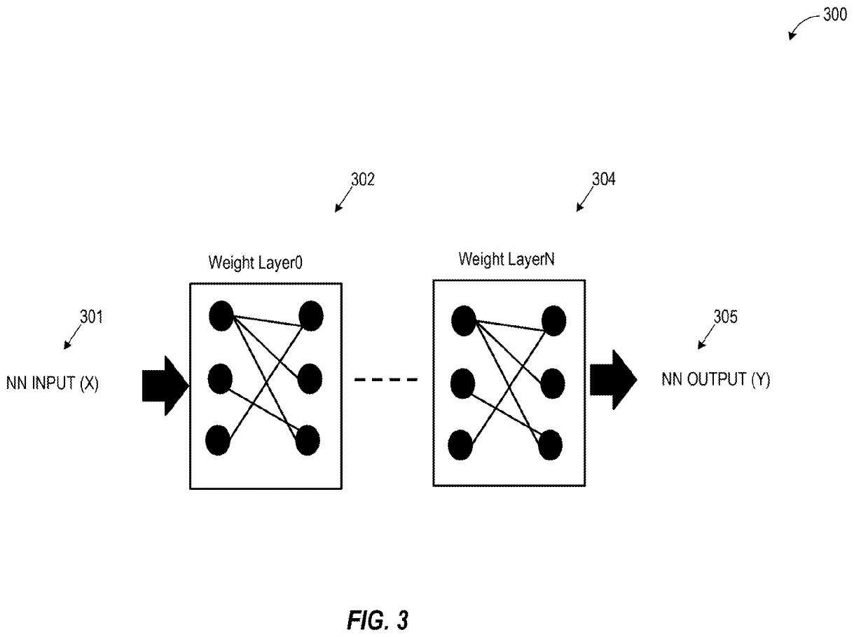

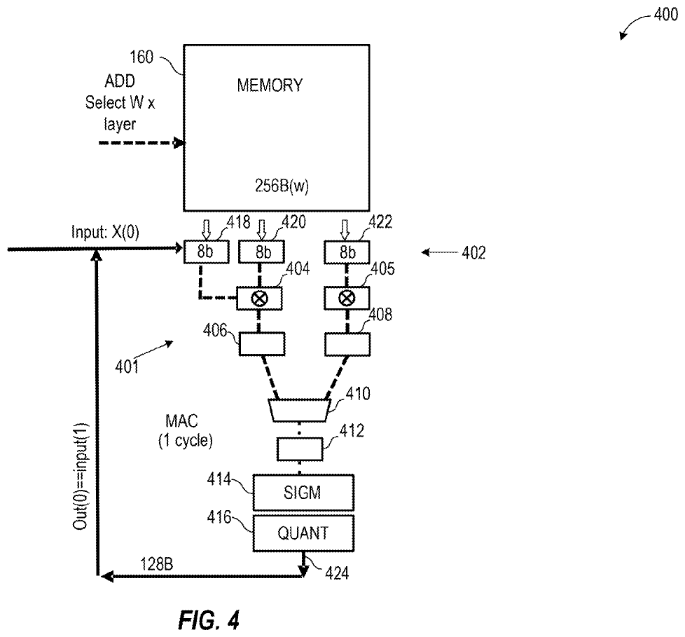

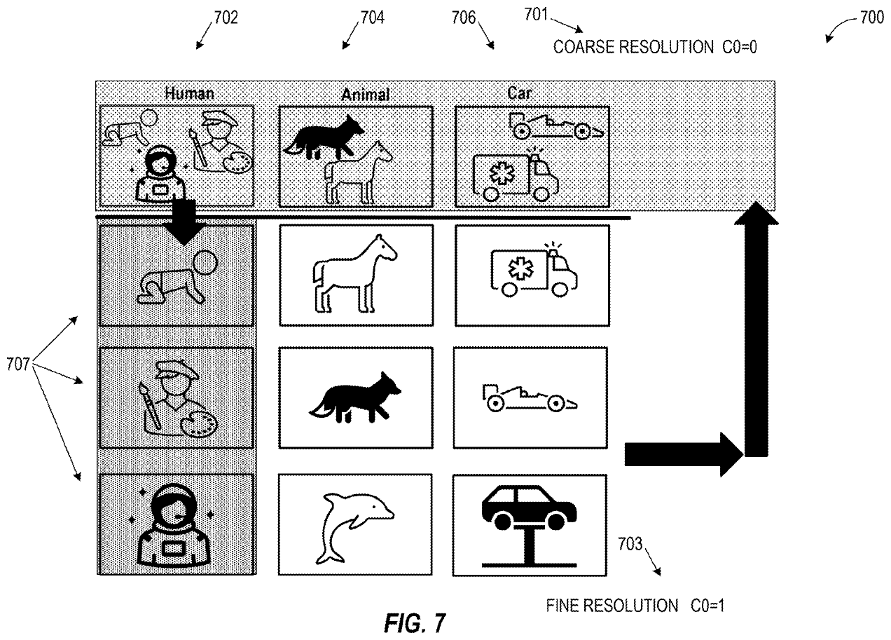

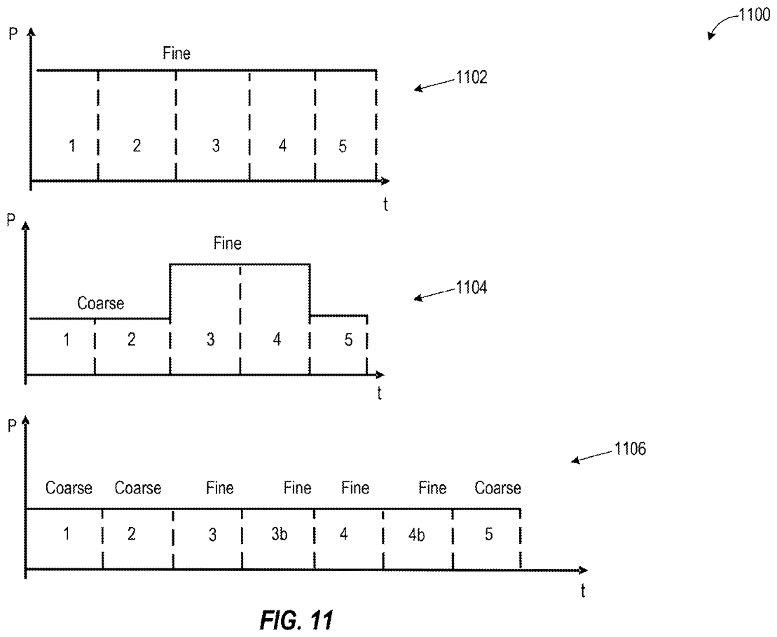

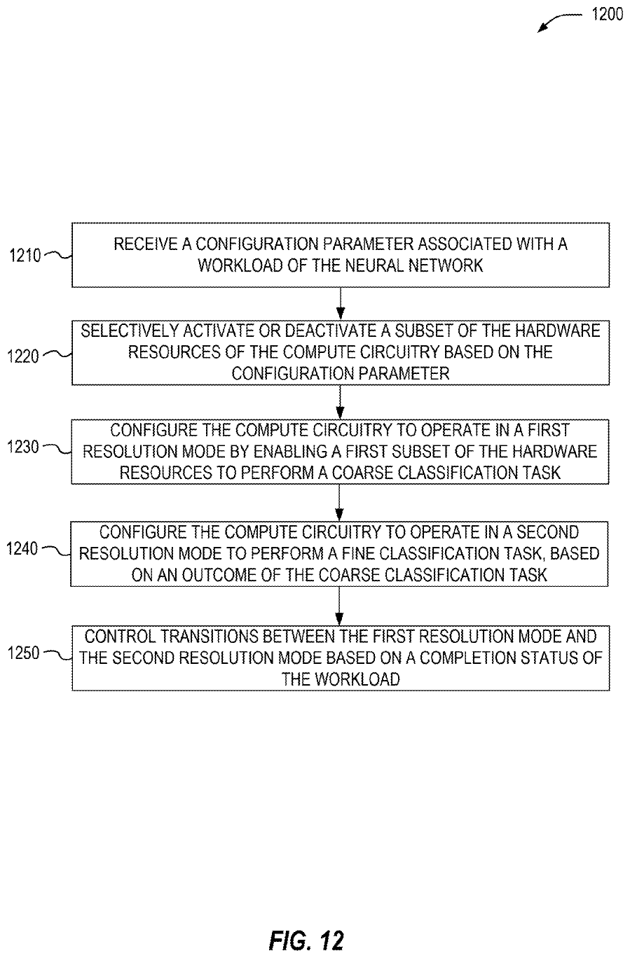

The following figures illustrate various aspects of the disclosed techniques and circuitry. FIG. 1 provides an overview of a computing system architecture suitable for implementing these techniques and circuitry. FIG. 2 details the block diagram of the NN manageability engine responsible for hardware configuration and telemetry management. FIG. 3 depicts a schematic of a neural network with multiple layers, while FIG. 4-FIG. 6 show the hardware circuitry used for NN operations in connection with image data. FIG. 7 illustrates the process of switching between coarse and fine resolution modes for classification tasks. FIGS. 8 and 9 present the main examples of the disclosed techniques and circuitry, showing configurable NN circuits that enable selective activation and deactivation of hardware resources for dynamic resolution and power management. FIG. 11 presents graphs demonstrating power consumption profiles under different resolution and power management scenarios. Graph 1102 refers to the implementation with FIG. 4 configurations. Graph 1104 refers to the implementation with FIG. 8 configurations, and graph 1106 refers to the implementation with FIG. 9 configurations. FIG. 12 is a flowchart of a method to perform the disclosed techniques and circuitry.

FIG. 1 depicts an architecture of a computing system having processor circuitry usable with the present power configuration techniques and circuitry. Referring to FIG. 1, the architecture includes a compute platform 120 (e.g., provided from processing circuitry implemented as a SoC, System-on-Package (SoP), System-in-a-Package (SiP), or as a compartmentalized chipset with multiple chips and packages) that includes a network interface 121 to perform I/O operations (e.g., with network communication circuitry), hardware elements 123 (e.g., implemented by specialized compute circuitry such as a central processing unit (CPU), accelerator, and constituent elements such as cores, caches, controllers, etc.), and an artificial intelligence application (or AI app) 125 and a management software stack 122 (e.g., loaded software instructions and data associated with management software 110) that execute on the hardware elements 123. The hardware elements 123 may be implemented in the compute platform 120 as specialized compute circuitry to perform compute operations for some workload.

The compute platform 120 is further configured with hardware manageability circuitry (also referred to as neural network (NN) manageability engine 140), which can perform disclosed power configuration techniques and circuitry. A more detailed diagram of the NN manageability engine is illustrated in FIG. 2.

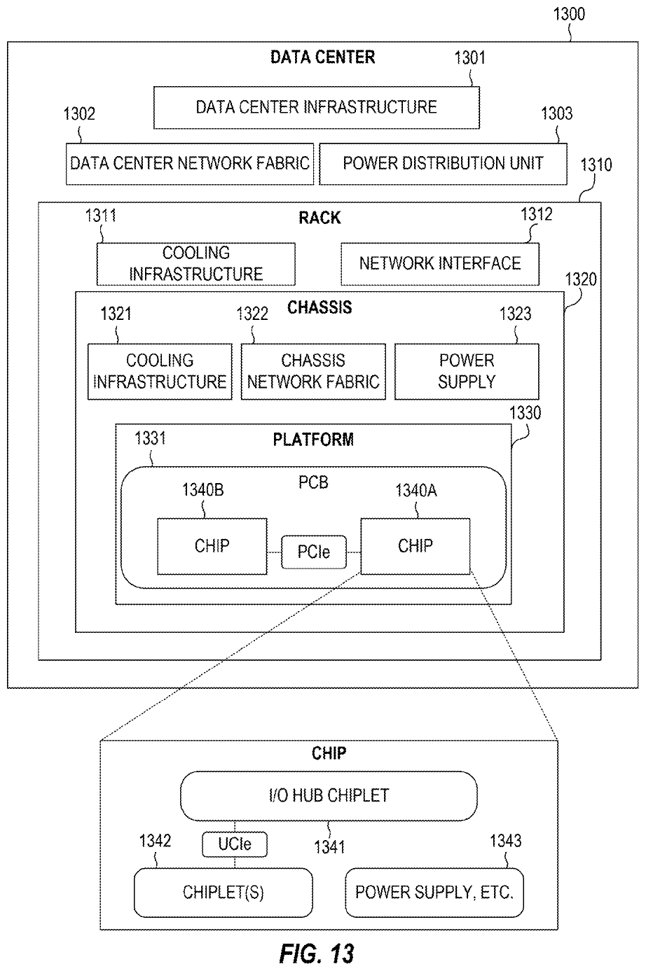

The compute platform 120 is also depicted as including a memory controller 150 (e.g., memory controller circuitry implemented on the same package as the hardware elements 123 or nearby the hardware elements 123). The memory controller 150 is used to write and read data from memory units 160A, 160B, 160C, such as respective memory channel modules (e.g., dual in-line memory modules (DIMMS) such as SDRAM modules). Additional implementation examples of the compute platform 120 are provided with reference to FIGS. 13, 14A, 14B, and 15, discussed below.

The memory units 160A, 160B, and 160C are connected to the compute platform 120 through the memory controller 150, enabling high-bandwidth data transfer between the processing hardware and memory resources. This configuration supports the storage and retrieval of neural network weights, input data, intermediate results, and AI artifacts generated during distributed NN training and inference operations.

External device 170 is shown as a source of input data, such as image or video streams, which can be processed by the AI application 125 running on the compute platform 120. The architecture supports flexible integration with a variety of external sensors, cameras, or data sources, enabling the system to adapt to different application domains and deployment scenarios.

The management software 110 is shown as a separate entity, which may be implemented on-cloud or on-premises, and communicates with the compute platform 120 via in-band or out-of-band communications 112. This arrangement allows for remote or centralized management of the compute platform, including the ability to monitor, configure, and control hardware resources and operational parameters from outside the local system. In some aspects, the management software 110 can be deployed as part of the compute platform 120.

The compute platform 120 may be adapted to receive commands from a management software stack 122, such as an on-cloud implementation of management software 110. The management software stack 122 may provide in-band or out-of-band communications 112 (e.g., received via the network interface 121) that monitor the state of the hardware elements and provide commands to respond to system conditions and change settings. The management software stack 122 may collect and analyze telemetry data in response to hardware events detected within the hardware elements 123 and provide changes to hardware configuration settings based on detected conditions. For instance, the management software stack 122 may perform power management and other system-wide control functions that change hardware operations of the compute platform 120, using remedial actions that respond to events and conditions indicated in telemetry data.

In some aspects, the compute platform 120 receives information (e.g., image/video data) from the external device 170. The image/video data may be received and provided to software such as the AI app 125 executing on hardware elements 123. The AI app 125 may directly or indirectly create, use, or modify an AI artifact 134. As used herein, an AI artifact refers to an output (e.g., complete or final) or an intermediate (e.g., incomplete or partial) value or sets of one or more values (e.g., data or data sets such as weights, transformations, graphs, classifications, etc.) generated during the process of developing, training, deploying, or using a NN model in connection with distributed (e.g., multi-entity) NN operations (also called “tasks”).

Although the disclosed techniques and circuitry are described in detail in connection with image and video data processing, it should be understood that the same principles are broadly applicable to other types of data and data scenarios. For example, the described fine, coarse, and intermediate resolution modes may be used in processing audio signals, sensor data, time-series data, text, or any other data type where it is advantageous to first identify areas or features of interest using a lower power, coarse mode, and then transition to a higher or more refined resolution to perform more detailed analysis or processing on those areas of interest. The ability to dynamically adjust the resolution and hardware resource allocation based on the characteristics of the data or the detection of specific events is not limited to image-related applications, but extends to any context where hierarchical or multi-stage data analysis is beneficial. This flexibility allows the disclosed techniques and circuitry to support a wide range of use cases across different domains, including but not limited to, anomaly detection in network traffic, event detection in sensor networks, or hierarchical parsing in natural language processing.

For example, consider a scenario where image data is received from external device 170 (e.g., a camera), and the AI app 125 uses a pre-trained NN model (e.g., configured by hardware elements 123 using memory 160) to perform one or more AI operations (e.g., classification) based on the image data. The AI app 125 may create an AI artifact 134 as a result of the AI operation. The AI artifact 134 may provide data that takes the form of a prediction, gradient, or even a modified model.

For example, in the context of financial data analysis, the system may initially monitor high-frequency trading data or market indicators in a coarse, low-power mode to quickly identify patterns or anomalies within a particular data geometry, such as rapid price movements or unusual trading volumes over specific time windows or asset classes. Upon detecting such a pattern within the relevant data geometry, the system can automatically transition to a fine resolution mode, activating additional computational resources to perform a more detailed analysis—such as running advanced predictive models, calculating risk metrics, or simulating potential market scenarios—focused on the specific data geometry of interest.

Similarly, in the domain of network security, the system may process network traffic logs or packet flows in a coarse mode to efficiently scan for general signs of abnormal activity within the network's data geometry, such as spikes in traffic or deviations from typical usage patterns across different segments or time intervals. When a potential threat or anomaly is detected within a particular data geometry, the system can switch to a fine resolution mode to conduct a deeper inspection, such as analyzing packet payloads, correlating events across multiple sources, or applying sophisticated intrusion detection algorithms to the identified subset of the data geometry.

These examples illustrate that the disclosed techniques and circuitry are not limited to image or video data, but are broadly applicable to any scenario where it is advantageous to use a lower-power, coarse analysis to notice areas or periods of interest within a given data geometry, and then employ fine-level compute to perform a deeper, more resource-intensive investigation on those specific data geometries or features.

In the compute platform 120, various types of distributed NN tasks can be executed on the hardware elements 123. This is shown respectively with distributed NN training and inference operations 130 occurring on compute platform 120. In the distributed NN training and inference operations 130, one or more AI data processing actions may be performed with one or more AI artifacts. The results of the distributed NN training and inference operations are shown with the creation of an AI artifact 134 used by the AI app 125. In some aspects, each instance of the intermediate AI artifact 134 can include a discrete data set that includes information such as weights, values, a prediction, or other information representations (e.g., which can be based on input data received from external device 170).

The compute platform 120 is shown as including various changeable system settings, which are generally referred to as “knobs” or “configuration knobs”, referring to the analogy of a rotating “knob” that can be actuated in either direction to increase or decrease some operational characteristic of the platform circuitry (e.g., by defining a value within some available range of values) that cause some effect and performance impact on the overall platform. Such knobs may be implemented by a control register such as a model-specific register (MSR) in an x86 processor architecture, System Control Registers (SCRs) in an ARM processor architecture, a Control and Status Register (CSR) in a RISC-V processor architecture, and the like. Some of these registers may be visible and discoverable to the management software stack 122 and the NN manageability engine 140, such as those register settings included in visible configuration registers 131; other registers may not be visible and discoverable, as shown with hidden configuration registers 132.

In some aspects, the NN manageability engine 140 provides the disclosed power configuration techniques and circuitry in connection with one or more NNs implemented by the hardware elements 123 (e.g., using memory 160). In some aspects, the power configuration techniques and circuitry include activating (e.g., powering ON) or deactivating (e.g., powering OFF or placing in a low-power mode) one or more hardware components used by a NN (e.g., to generate AI artifact 134 or perform another AI-based task for the AI app 125). Example hardware components used by a NN and managed by the NN manageability engine 140 include input registers, multiplier circuits, adder circuits, result registers, sigmoid function circuits, quantization circuits, and so forth. As used herein, the term multiplication-addition circuit (MAC) refers to a combination of at least one multiplier circuit and at least one adder circuit used in connection with implementing an NN. In some aspects, a MAC can also include other circuits in addition to at least one multiplier circuit and at least one adder circuit.

In some aspects, the NN manageability engine 140 performs the disclosed power configuration techniques and circuitry based on one or more configuration settings (or knobs), such as settings stored in the visible configuration registers 131, the values used in the hidden configuration registers 132, and other registers or hardware element features of the platform. In some aspects, the configuration settings used by the NN manageability engine 140 can be indicated or configured by the management software stack 122. In some aspects, the configuration settings used by the NN manageability engine 140 can be indicated or configured based on telemetry data collected by the compute platform 120 (e.g., hardware resource utilization).

In some aspects, the NN manageability engine 140 can be configured as part of the hardware elements 123.

In some aspects, the NN manageability engine 140 is implemented by an AI agent. An AI agent is hardware, software, and/or firmware that is capable of autonomously performing a task. For example, an AI agent is implemented by at least one artificial intelligence/machine learning (AI/ML) model such as an NN (e.g., a convolutional neural network (CNN), a recurrent NN (RNN), a long short-term memory (LSTM) network, a Deep Belief Network (DBN), an autoencoder network, an encoder-decoder network, a generative adversarial network (GAN), a radial basis function network (RBFN), a Multi-Layer Perception (MLP) network, a large-language model (LLM), etc.). An AI agent can be implemented as a simple reflex agent, a model-based reflex agent, a goal-based agent, a utility-based agent, or a learning agent, among others. In some examples, an AI agent can be updated after deployment (e.g., by an administrator of a compute deployment, by a provider of the AI agent, etc.).

A simple reflex agent refers to an AI agent that takes actions based on presently available information. As such, a simple reflex agent may not utilize memory or interact with other agents (if the simple reflex agent is missing information in an input). A model-based reflex agent refers to an AI agent that takes actions based on presently available information and memory to maintain a model of an environment in which the AI agent is deployed. As such, a model-based reflex agent can be updated as new information is received or learned.

A goal-based agent refers to an AI agent that includes a model of an environment in which the AI model is deployed. A goal-based agent takes actions based on the model and at least one goal. As such, a goal-based agent can search for a sequence of actions to achieve a goal. A utility-based agent refers to an AI agent that selects a sequence of actions to achieve at least one goal and to increase (e.g., maximize) utility, for example, measured by a reward function.

A learning agent refers to an AI agent that can learn from new information autonomously. A learning agent can be goal-based or utility-based in reasoning. A learning agent includes (1) a learner to learn from an environment in which the learning agent is deployed, (2) a critic to provide feedback on at least one action taken by the learning agent satisfied a threshold (e.g., reward, goal, etc.), (3) an actor to select an action to be performed by the learning agent, and (4) an action generator to propose at least one candidate action to be taken. As such, learning agents can achieve better performance than other AI agents in unfamiliar environments.

FIG. 2 depicts the implementation details of the NN manageability engine 140, according to an embodiment. Referring to FIG. 2, the NN manageability engine 140 includes interfaces 202, hardware configurations sweep logic 204, system telemetry data 206, visible configurations 208, hidden configurations 210, and a hardware controller 212. In some aspects, other configurations are possible for the NN manageability engine 140, depending on its desired telemetry focus and still be within this contemplated functional element.

The NN manageability engine 140 can be configured as a hardware module designed to monitor, control, and dynamically adjust (e.g., via the hardware controller 212) the operational parameters of NN processing hardware, including deactivation and activation of the hardware (e.g., based on one or more of the system telemetry data 206, the visible configurations 208, and the hidden configurations 210). The NN manageability engine 140 can be configured as the central unit for implementing power configuration and telemetry management techniques and circuitry within the compute platform 120.

Interfaces 202 provide connectivity between the NN manageability engine 140 and other system components, such as the compute platform 120, the management software 110, memory 160, and external device 170 (which can include data sources and external telemetry sources). These interfaces enable the exchange of configuration commands, telemetry data, and status information necessary for coordinated system management, including NN hardware management and configuration.

Hardware configurations sweep logic 204 comprises suitable interfaces, logic, or code, and is responsible for retrieving and evaluating different hardware configuration settings, such as the system telemetry data 206, the visible configurations 208, and the hidden configurations 210. This logic module can systematically adjust (e.g., via the hardware controller 212) hardware configurations and operational parameters (e.g., power states, resolution modes, or resource allocation), based on input from the system telemetry, configuration registers, or external commands. As used herein, the terms “system conditions,” “power states,” “resolution modes,” and “resource allocation” refer to the tools or mechanisms by which the system can operate at a less fine and more resource-efficient resolution. These tools enable the system to reduce computational precision, deactivate or limit hardware resources, and lower power consumption during coarse analysis, reserving higher precision and resource-intensive operations for periods when finer resolution is required.

In some aspects, the hardware configurations sweep logic 204 can include telemetry management circuitry dedicated to detecting communication flows, retrieving telemetry configurations, executing traces on metrics, and performing actions based on telemetry results to optimize system operation.

System telemetry data 206 represents the collection of real-time operational metrics and environmental information from various hardware components. This data may include power consumption, temperature, utilization rates, and other performance indicators. The telemetry data is used by the hardware configurations sweep logic 204 to inform configuration decisions and optimize system operation.

Visible configurations 208 can be stored by the visible configuration registers 131 and can include hardware configuration settings that are accessible and modifiable by both the management software stack 122 and the NN manageability engine 140. These settings may include control registers, power state selectors, or resolution mode switches, and allow for dynamic adjustment of hardware behavior (e.g., configuration of NN hardware) in response to system conditions.

Hidden configurations 210 can be stored by the hidden configuration registers and can include hardware configuration settings that are not directly accessible or discoverable by management software. These may include internal registers or proprietary control mechanisms that influence hardware operation but can be managed by the NN manageability engine 140 or other secure system components of the compute platform 120.

The hardware controller 212 executes the configuration changes determined by the hardware configurations sweep logic 204. It directly manages the activation, deactivation, or reconfiguration of hardware resources, such as powering on or off specific circuits, adjusting resolution modes, or modifying resource allocation to neural network processing elements.

Operationally, the NN manageability engine 140 receives (or retrieves) system telemetry data 206 from various sensors and hardware monitors throughout the compute platform 120. The hardware configurations sweep logic 204 analyzes this data, along with input from visible configurations 208 and hidden configurations 210, to determine optimal hardware settings for one or more NNs operating within the compute platform 120. Interfaces 202 facilitate communication with external management software or other system modules, allowing for coordinated control of NN hardware (e.g., any of the NN hardware discussed in connection with FIG. 4 and FIGS. 8-10). When a configuration change is required, the hardware controller 212 implements the necessary adjustments at the hardware level, ensuring that the system operates in a power-efficient mode (e.g., in an ultra-low power mode). These tools are applied dynamically to match the operational requirements of the workload, enabling the system to transition between coarse and fine resolution as needed. Example power management configurations for different types of ultra-low power mode operation are discussed in connection with, e.g., FIG. 8 and FIG. 9.

FIG. 3 depicts an example NN 300 with multiple layers, according to an embodiment. Referring to FIG. 3, NN 300 includes a plurality of weight layers, such as NN layer 302, . . . , NN layer 304.

The NN input 301 represents the entry point for data into the neural network. This input may include raw data such as images, sensor readings, or other feature vectors that are to be processed by NN 3000. In some aspects, NN input 301 is formatted as a vector or matrix, depending on the application and the architecture of the neural network. As used herein, the term “input data” may include, but is not limited to, images, sensor readings, audio signals, time-series data, data streams characterized by particular shapes or slopes, and data collected in either fixed or dynamic windows. These data types may be processed by the neural network to identify features, patterns, or events of interest, and the disclosed techniques and circuitry are applicable to scenarios where the system adapts its resolution and resource allocation based on the geometry or temporal characteristics of the incoming data.

NN layer 302 is the first processing layer of NN 300. This layer receives the input data and applies a set of weights and activation functions to transform the input. The layer may consist of multiple neurons, each performing a weighted sum of the inputs, followed by a nonlinear activation. The output of this layer serves as the input to subsequent layers.

NN layer 304 represents a subsequent or final processing layer in the NN 300. Like the first layer, this layer applies its own set of weights and activation functions to the data received from the previous layer. The number of layers and the specific operations performed in each layer of NN 300 can vary depending on the network architecture and the complexity of the task.

The NN output 305 is the final output of the neural network. This output may represent a classification result, a regression value, or another form of processed data, depending on the application (e.g., AI app 125 using the NN 300 configured according to disclosed techniques and circuitry). The output is typically used by downstream systems or applications to make decisions or trigger further actions.

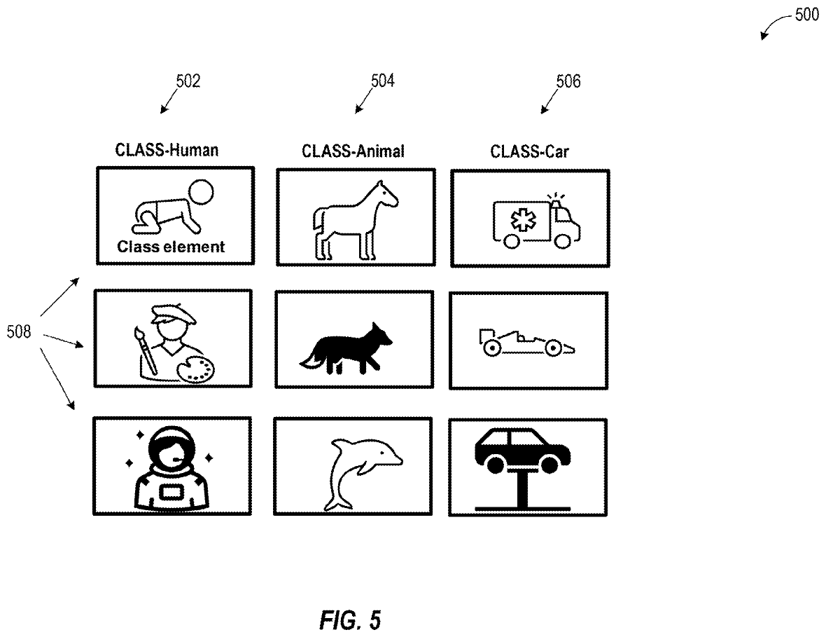

In some aspects, NN 300 can be configured to perform image detection, such as detecting an image class and then an image sub-class, as discussed in connection with FIG. 5.

FIG. 4 depicts NN circuitry 400 configured to process data and identify classes and sub-classes at a full resolution, according to an embodiment. Referring to FIG. 4, NN circuitry 400 includes memory 160, a plurality of input registers 402 (including INT8 input registers 418, 420, and 422), MAC 401 (including multiplier circuits 404 and 405, and adder circuit 410), result registers 406, 408, and 412, sigmoid function circuit 414, and quantization circuit 416.

In some aspects, MAC 401 can be configured to include circuits used in the core computation for the neural network layer, such as multiplier circuits 404 and 405, adder circuit 410, the plurality of input registers 402, result registers 406, 408, and 412, sigmoid function circuit 414, and quantization circuit 416.

The memory 160 stores both the input data (such as feature vectors or image data) and the weights required for neural network computations. In some aspects, memory 160 is organized to provide 128 bytes of input data and 256 bytes of weight data per access, supporting data retrieval for each layer of the neural network.

Input registers 418, 420, and 422 are used to temporarily hold the input data and corresponding weights fetched from memory 160. Each of the input registers is configured to store 8 bits of data, enabling parallel access to multiple data elements required for the subsequent computation.

Multiplier circuits 404 and 405 perform the core multiplication operations between the input data and the associated weights of the NN. These circuits are responsible for generating the products that form the basis of the neural network's weighted sum calculations.

Result registers 406 and 408 store the intermediate results produced by the multiplier circuits 404 and 405. These registers ensure that the products are available for further processing, such as accumulation and activation.

Adder circuit 410 receives the outputs from the result registers and performs the accumulation (addition) of the products. This operation generates the weighted sum used in the neural network layer computations.

Result register 412 holds the accumulated sum produced by the adder circuit 410. This value represents the pre-activation output of the neuron and is passed to the next stage for non-linear transformation.

The sigmoid function circuit 414 applies a non-linear activation function (such as a sigmoid) to the accumulated sum. This transformation introduces non-linearity into the neural network, enabling it to model complex relationships in the data. In some aspects, the sigmoid function circuit 414 detects whether the input from the result register 412 is higher than a threshold, which can be used to confirm a NN processing result (e.g., an image detection of a class or sub-class has occurred based on the threshold).

Quantization circuit 416 reduces the bit-width of the activated output (e.g., 21 bits) to a desired resolution, such as 8 bits, to optimize storage and further processing. This operation can be used to ensure the quantized output 424 is compatible with subsequent layers of the NN or output interfaces.

The quantized output 424 represents the final processed result of the neural network layer, which can be used as the input to the next layer or as the final output for classification or regression tasks.

In operation, memory 160 provides the required input data and weights to the INT8 input registers 418, 420, and 422. The multiplier circuits 404 and 405 then compute the products of the inputs and weights, which are stored in result registers 406 and 408. The adder circuit 410 accumulates these products, and the result is stored in the result register 412. The accumulated sum is then passed through the sigmoid function circuit 414 for non-linear activation, followed by quantization in circuit 416. The quantized output 424 is then available for further processing (e.g., communicated as input to the input register 418 for subsequent processing by the next NN layer) or output.

FIG. 5 introduces the concept of hierarchical classification, where images are first grouped into broad classes and then further distinguished into sub-classes. In the context of the present disclosure, “resolution” refers to the level of detail at which data is analyzed or processed, which may be characterized by time granularity, data density, or shape properties, depending on the data type being analyzed. For example, in image data, resolution may correspond to pixel density or the size of the region being classified, while in time-series or streaming data, resolution may relate to the size of the time window or the frequency of sampling. This figure provides a visual context for understanding how the disclosed techniques and circuitry enable dynamic resolution switching in neural network hardware, allowing the system to adaptively select the appropriate level of detail—whether coarse, intermediate, or fine—based on the data geometry and the requirements of the analysis. By supporting multiple resolution levels, the system can efficiently allocate computational resources and power, focusing detailed analysis only on areas or periods of interest within the data.

FIG. 5 depicts an example image set 500 separated by classes and sub-classes, which can be used in connection with the disclosed techniques and circuitry, according to an embodiment. Referring to FIG. 5, image set 500 includes a plurality of images grouped into image classes 502 (e.g., CLASS-Human), 504 (e.g., CLASS-animal), and 506 (e.g., CLASS-Car). Each of the classes can be further classified into one or more sub-classes 508. While this section is presented in terms of images, it should be understood that still and video images are used as a representative data type because they inherently contain all the properties of resolution options—such as spatial density, region size, and temporal granularity—that the compute system may consider and adjust. The use of images provides a convenient and illustrative context for describing the processes of hierarchical classification and dynamic resolution switching. However, the disclosed techniques and circuitry are not limited to image data and are broadly applicable to other data types that exhibit similar properties, such as time-series, sensor data, or streaming information, where resolution may be defined by time, data density, or shape characteristics.

In some aspects, image set 500 includes a collection of images that are used as input data for NN processing. This set is organized to demonstrate how images can be categorized at different levels of granularity, supporting both class-level and sub-class-level identification.

Image class 502, labeled as CLASS-Human, groups together images that are broadly identified as belonging to the human category. This class may include various types of human figures or activities, serving as a high-level classification target for the neural network.

Image class 504, labeled as CLASS-animal, groups together images that are identified as animals. This class encompasses a range of animal types, providing another example of a high-level category that the neural network can detect.

Image class 506, labeled as CLASS-Car, groups together images that are identified as cars. This class includes different types of vehicles, representing another distinct high-level category for classification.

Image sub-classes 508 represent more specific categories or elements within each main class. For example, within the CLASS-Human category, sub-classes may include images of a baby, an artist, or an astronaut. Within the CLASS-animal category, sub-classes may include a horse, a fox, or a dolphin. Within the CLASS-Car category, sub-classes may include an ambulance, a race car, or a sedan. These sub-classes illustrate the neural network's ability to perform fine-grained classification once a main class has been detected.

Operationally, the neural network first processes the input image set 500 to identify which high-level class (e.g., any of classes 502, 504, or 506) an image belongs to. This initial classification may be performed in a gross or coarse resolution mode, using reduced hardware resources for power efficiency. Upon detecting a specific class, the system can then transition to a fine resolution mode to further analyze the image and reach the full resolution to identify the specific sub-class 508 within the detected class. The fine resolution mode can also be performed with reduced hardware resources (e.g., using a different subset of hardware resources, such as illustrated in FIG. 8, or using the same subset of hardware resources, such as illustrated in FIG. 9). This two-stage process enables both efficient power usage and high-precision classification.

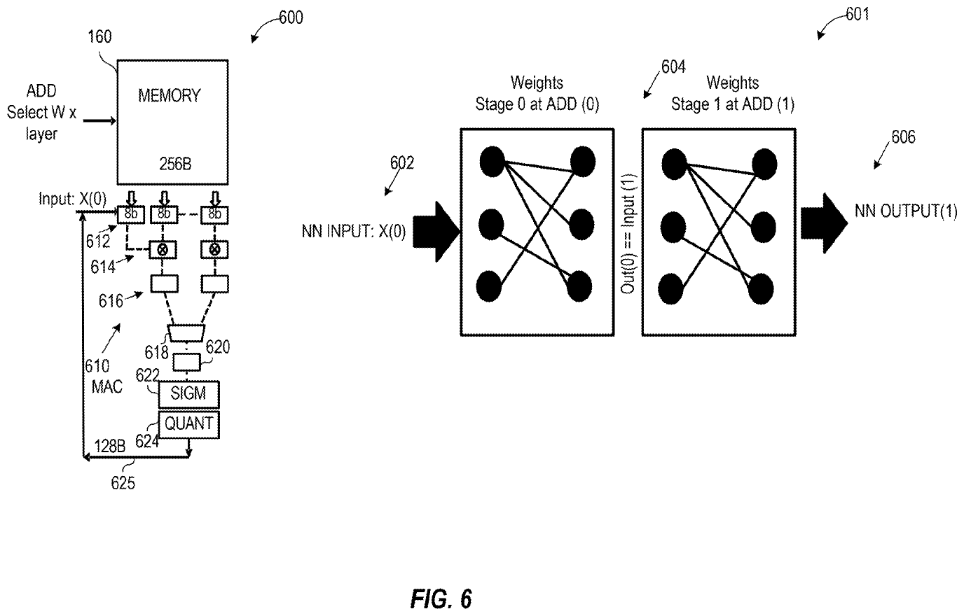

FIG. 6 depicts the equivalence between an example NN 601 with multiple layers (which can be the same as NN 300) and NN circuitry 600 (which can be the same as NN circuitry 400). Referring to FIG. 6, NN circuitry 600 includes memory 160, a plurality of input registers 612 (including INT8 or INT4 input registers), MAC 610 (including multiplier circuits 614 and adder circuit 618), result registers 616 and 620, sigmoid function circuit 622, and quantization circuit 624.

In some aspects, MAC 610 can be configured to include circuits used in the core computation for the neural network layer comprised of NN layers 604, such as multiplier circuits 614, adder circuit 618, the plurality of input registers 612, result registers 616 and 620, sigmoid function circuit 622, and quantization circuit 624. A representation of the NN 601 (composed of blocks 602, 604, and 606) can be implemented in circuits with blocks 160, 610, 612, 614, 616, 622, 624, and 625.

The memory 160 can store the input data (such as feature vectors or image data) and the weights of the NN layers 604 required for neural network computations. In some aspects, memory 160 is organized to provide 128 bytes of input data and 256 bytes of weight data per access (configured to store the input of each stage, which is the same as the output of the previous stage, into the memory), or alternatively, store the weights into the memory while the input at the first stage and the subsequent inputs for the inner stages are stored directly in registers 612. The memory 160 can support data retrieval for each layer of the neural network.

Input registers 612 are used to temporarily hold the input data and corresponding weights fetched from memory 160. Each of the input registers is configured to store 8 bits of data, enabling parallel access to multiple data elements required for the subsequent computation.

Multiplier circuits 614 perform the core multiplication operations between the input data and the associated weights of the NN layers 604. These circuits are responsible for generating the products that form the basis of the neural network's weighted sum calculations.

Result registers 616 store the intermediate results produced by the multiplier circuits 614. These registers ensure that the products are available for further processing, such as accumulation and activation.

Adder circuit 618 receives the outputs from the result registers and performs the accumulation (addition) of the products. This operation generates the weighted sum used in the neural network layer computations.

Result register 620 holds the accumulated sum produced by the adder circuit 618. This value represents the pre-activation output of the neuron and is passed to the next stage for non-linear transformation.

The sigmoid function circuit 622 applies a non-linear activation function (such as a sigmoid) to the accumulated sum. This transformation introduces non-linearity into the neural network, enabling it to model complex relationships in the data. In some aspects, the sigmoid function circuit 622 detects whether the input from the result register 620 is higher than a threshold, which can be used to confirm a NN processing result (e.g., an image detection of a class or sub-class has occurred based on the threshold).

Quantization circuit 624 reduces the bit-width of the activated output (e.g., 21 bits) to a desired resolution, such as 8 bits, to optimize storage and further processing. This operation can be used to ensure the quantized output 625 is compatible with subsequent layers of the NN or output interfaces.

The quantized output 625 represents the final processed result of the neural network layer, which can be used as the input to the next layer or as the final output for classification or regression tasks.

In operation, memory 160 provides the required input data (such as NN input 602) and the weights of NN layers 604 (e.g., weights of the first NN layer) to the input registers 612. The multiplier circuits 614 then compute the products of the inputs and weights, which are stored in result registers 616. The adder circuit 618 accumulates these products, and the result is stored in the result register 620. The accumulated sum is then passed through the sigmoid function circuit 622 for non-linear activation, followed by quantization in the quantization circuit 624. The quantized output 625 is then available for further processing (e.g., communicated as input to the input register 612 for subsequent processing by the next NN layer) or output. After NN processing completes, the final quantized output 625 is communicated as NN output 606.

In some aspects, the quantized output 625 can include a configuration parameter (also referred to as C0), which can be used as a control input that determines the operational mode of the NN circuitry. In some aspects, C0 can be used to switch between different resolutions (e.g., coarse or fine) and to select different hardware configurations for power and performance optimization (e.g., as discussed in connection with FIG. 8 and FIG. 9).

In some aspects, the quantized output itself can be used as the configuration parameter. For example, the NN manageability engine 140 can detect that the quantized output 625 includes a detected image class, indicating coarse resolution mode detection has completed. Such determination can then trigger fine resolution mode detection using the same or a different subset of NN hardware.

In some aspects, the configuration parameter can be generated by the NN manageability engine 140 based on the quantized output 625 being associated with a sigmoid function result that is higher than a pre-configured threshold.

In other aspects, the configuration parameter used for switching resolution mode and configuring ultra-low power operation of the NN hardware can be generated automatically by the NN manageability engine 140 (e.g., based on a timer, based on system resource utilization, or other telemetry data, based on the quantized output 625, based on a user-defined schedule or command, or other criteria).

In operation, NN input 602 is provided to the first NN layer of NN layers 604, where it is processed using weights stored in memory 160. The input data and weights are loaded into input registers 612, then processed by the MAC 610, which includes multiplier circuits 614 and adder circuit 618. Intermediate results are stored in result registers 616 and 620. The accumulated sum is passed through the sigmoid function circuit 622 for activation, and the output is quantized by circuit 624. The configuration parameter controls whether the circuitry operates in a coarse or fine resolution mode, enabling dynamic switching between different hardware configurations for power efficiency or high-precision processing. The final result is output as NN output 606, which may indicate a detected class or sub-class.

FIG. 7 depicts an example image set 700 separated by classes and sub-classes that can be selected based on a hardware configuration, according to an embodiment. The image set 700 represents a collection of images organized for neural network processing. This set is structured to demonstrate how images can be grouped into broad classes and further divided into sub-classes, supporting hierarchical classification tasks.

The data representing these classes in FIG. 7 typically consists of digital images, which may be formatted as arrays or matrices of pixel values. Each image in the set 700 can be stored in standard formats such as JPEG, PNG, BMP, or as raw pixel data, where each pixel is defined by intensity values (e.g., grayscale) or by color channels (e.g., RGB or YUV). The images are organized in a manner that allows them to be grouped into broad classes (such as “human,” “animal,” or “car”) and further divided into sub-classes (such as “baby,” “artist,” “horse,” or “race car”).

In the processing described here, elements of the image format that are used include the pixel intensity values, spatial arrangement of pixels, and potentially metadata such as image dimensions or color depth. The neural network processes these pixel arrays as input feature vectors, extracting patterns, edges, textures, or other visual features relevant to classification. During coarse resolution processing, the network may use down-sampled or lower bit-width representations of the images to quickly identify the broad class. For fine or intermediate resolution processing, higher-resolution or full bit-width pixel data may be used to distinguish sub-classes or finer details within the image. The hierarchical structure of the data—where images are first grouped by class and then by sub-class—enables the neural network to apply dynamic resolution switching and resource allocation based on the detected class or area of interest within the image data geometry.

Referring to FIG. 7, image set 700 includes images associated with image classes 702, 704, and 706, and image sub-classes 707. Image class 702 includes images that are broadly identified as belonging to the human category. This class serves as a high-level target for initial, coarse classification by the neural network. Image class 704 and image class 706 represent additional main classes, such as animal and car, each containing images that share common features. These classes illustrate the system's ability to distinguish between different broad categories during the initial classification stage.

Image sub-classes 707 represent more granular categories within each main class. For example, within the human class, sub-classes may include images of a baby, an artist, or an astronaut. Within the animal or car classes, sub-classes may include a horse, a fox, a delivery truck, or a race car. These sub-classes demonstrate the neural network's ability to perform fine-grained classification when operating in the fine resolution mode.

In some aspects, NN hardware (e.g., as illustrated in FIG. 8 and FIG. 9) can be configured to perform coarse resolution based on the coarse resolution setting 701. More specifically, the coarse resolution setting 701 (e.g., C0=0) indicates the operational mode in which the neural network processes input data from image set 700 using reduced hardware resources or lower bit-widths. In this mode, the system performs basic or class-level classification, identifying which main class an image belongs to while minimizing power consumption.

The fine resolution setting 703 (e.g., C0=1) indicates the operational mode in which the neural network utilizes additional hardware resources that can also be of lower bit-widths (or reuse the lower bit-width resources used during the coarse resolution). In this mode, the system performs detailed or sub-class-level classification, identifying specific elements within a detected class.

In operation, the neural network first processes the input image set 700 in the coarse resolution mode (C0=0), using minimal hardware resources to identify the main class of each image. Upon detecting a specific class, such as the human class (image class 702), the system can transition to the fine resolution mode (C0=1) to further analyze the image and identify the specific sub-class 707 within the detected class. This transition is controlled by hardware configuration parameters, allowing the system to dynamically switch between power-efficient and high-precision processing as needed.

In other embodiments, the system is not limited to only two operational modes. Instead, multiple resolution modes can be implemented, such as coarse, intermediate, and fine, or even additional sub-levels of granularity. For example, after an initial coarse resolution pass identifies a main class, the system may transition to an intermediate resolution mode to perform a more detailed analysis that narrows down potential sub-classes or regions of interest, before finally entering a fine resolution mode for the highest level of detail. The selection and transition between these multiple operational modes can be dynamically controlled by hardware configuration parameters, enabling the neural network to efficiently allocate computational resources and power based on the complexity or requirements of the data geometry being processed. This flexible approach allows for more nuanced and adaptive processing, supporting a broader range of use cases and data types.

FIG. 8 depicts NN circuitry 800 configured to process data and identify classes and sub-classes at different resolutions and using different hardware configurations for a full set of processing hardware, according to an embodiment. Referring to FIG. 8, NN circuitry 800 includes memory 160, a plurality of input sub-registers 805 (including INT4 input sub-registers 806, 808, 810, 812, 814, and 816), MAC 802 (including multiplier circuits 818 and 820, and adder circuit 834), MAC 804 (including multiplier circuits 822 and 824, and adder circuit 836), result registers 826, 828, 830, 832, 837, and 839, sigmoid function circuit 838, and quantization circuit 840.

In some aspects, MAC 802 can be configured to include circuits used during a first resolution mode (e.g., to perform a coarse classification task such as detecting an image class) in the core computation for the neural network layer, such as multiplier circuits 818 and 820, adder circuit 834, input sub-registers 806-810, and result registers 826, 828, and 837.

In some aspects, MAC 804 can be configured to include circuits used during a second resolution mode (e.g., to perform a fine classification task such as detecting an image sub-class) in the core computation for the neural network layer, such as multiplier circuits 822 and 824, adder circuit 836, input sub-registers 812-816, and result registers 830, 832, and 839.

In some aspects, the sigmoid function circuit 838 and the quantization circuit 840 can optionally be included in MAC 802 or MAC 804.

The memory 160 stores both the input data (such as feature vectors or the image data of FIG. 5 or FIG. 7) and the weights required for neural network computations. In some aspects, memory 160 is organized to provide 128 bytes of input data and 256 bytes of weight data per access, supporting data retrieval for each layer of the neural network.

Input sub-registers 806-816 are used to temporarily hold the input data and corresponding weights fetched from memory 160. Each of the input sub-registers is configured to store less than 8 bits of data (e.g., 4 bits of data), enabling parallel access to multiple data elements required for the subsequent computation.

Multiplier circuits 818-824 perform the core multiplication operations between the input data and the associated weights of the NN. These circuits are responsible for generating the products that form the basis of the neural network's weighted sum calculations.

Result registers 826-832 store the intermediate results produced by the multiplier circuits 818-824. These registers ensure that the products are available for further processing, such as accumulation and activation.

Adder circuits 834 and 836 receive the outputs from the result registers and perform the accumulation (addition) of the products. This operation generates the weighted sum used in the neural network layer computations.

Result registers 837 and 839 hold the accumulated sum produced by the adder circuits 834 and 836. These values represent the pre-activation output of the neuron and are passed to the next stage for non-linear transformation.

The sigmoid function circuit 838 applies a non-linear activation function (such as a sigmoid) to the accumulated sum. This transformation introduces non-linearity into the neural network, enabling it to model complex relationships in the data. In some aspects, the sigmoid function circuit 838 detects whether the input from the result register 837 or 839 is higher than a threshold, which can be used to confirm a NN processing result (e.g., an image detection of a class or sub-class has occurred based on the threshold, and processing can be switched from MAC 802 to MAC 804 or vice versa).

Quantization circuit 840 reduces the bit-width of the activated output (e.g., 21 bits) to a desired resolution, such as 4 bits, to optimize storage and further processing. This operation can be used to ensure the quantized output 841 is compatible with subsequent layers of the NN or output interfaces.

The quantized output 841 represents the final processed result of the neural network layer, which can be used as the input to the next layer or as the final output for classification or regression tasks.

In some aspects, configuration parameter 842 is a control input that determines the operational mode of the NN circuitry 800. This parameter is used by the neural network management circuitry (e.g., NN manageability engine 140) to selectively activate or deactivate subsets of the hardware resources (e.g., one or more of the plurality of input sub-registers 805 or other components of MAC 802 and MAC 804), and to control the resolution mode of the processing circuitry. For example, configuration parameter 842 is used to activate MAC 802 in a first resolution mode (e.g., to perform a coarse classification task such as detecting an image class). After completion of the coarse classification task (which can be detected by the quantization circuit 840), the configuration parameter 842 causes deactivation of MAC 802 and activation of MAC 804 to trigger a second resolution mode (e.g., to perform a fine classification task such as detecting an image sub-class). In some aspects, configuration parameter 842 can selectively configure exclusive execution of only the first resolution mode or alternating execution of the first and second execution modes (e.g., fine classification after coarse classification is complete).

It should be understood that, while the above description references image class and sub-class detection as examples, the disclosed techniques and circuitry are broadly applicable to detecting different data class types in a variety of data domains. For instance, the system may use a coarse resolution mode to identify a general category of network traffic, financial event, or sensor anomaly, and then transition to a finer resolution mode to classify a specific protocol, transaction type, or anomaly subtype. The configuration parameter 842 can thus be used to control operational modes for any data geometry or data class type, not limited to images. This omnibus approach ensures that the disclosed systems and methods are adaptable to a wide range of data types and application scenarios, supporting dynamic and efficient resource allocation for diverse classification and detection tasks.

In some aspects, the configuration parameter 842 can be used to activate (power ON), deactivate (power OFF), or place in a low-power mode individual hardware components of the NN circuit 800 or sub-circuits of such components. For example, the configuration parameter 842 can cause activation and use of a 4-bit sub-register that is part of an 8-bit register.

In some aspects, configuration parameter 842 is generated by the NN manageability engine 140 based on detected circuit configurations and telemetry provided by the hardware configurations sweep logic 204. In some aspects, the quantized output 841 can be used as the configuration parameter 842 (e.g., deactivate MAC 802 and initiate fine classification using MAC 804 when the quantized output 841 includes a detected image class after completion of coarse classification).

In some aspects, the NN manageability engine 140 is configured to perform an automatic wake-up by transitioning from a first resolution mode (e.g., for performing the coarse classification) to the second resolution mode (e.g., for performing the fine classification) in response to a trigger condition. In some aspects, the trigger condition is based on at least one of the following: the completion status of the workload being processed by the NN circuitry 800 and telemetry data received by the NN manageability engine 140 (e.g., telemetry data that exceeds a pre-configured value).

In some aspects, the NN manageability engine 140 can transition from performing the coarse classification to performing the fine classification, based on the outcome of the coarse classification task. For example, the transition can take place when the outcome indicates that coarse classification is complete. In some aspects, a different outcome can be preconfigured and indicated by the configuration parameter, and can be used for triggering the transition between the two resolution modes (e.g., trigger transition from coarse to fine resolution processing based on completing coarse resolution processing for at least 50% of the workload).

In operation, memory 160 provides the required input data and weights to the input sub-registers 805. In a first resolution mode (coarse classification task), the neural network management circuitry receives a configuration parameter 842 and selectively activates a first subset of the hardware resources, such as MAC 802 and its associated input sub-registers (e.g., 806-810). The multiplier circuits 818 and 820, along with result registers 826 and 828 and adder circuit 834, perform the necessary computations for gross classification. The output is processed through the sigmoid function circuit 838 and the quantization circuit 840, resulting in a quantized output 841.

Upon detecting completion of the coarse classification task, such as identification of a particular class, the NN manageability engine 140, based on the configuration parameter 842, transitions the compute circuitry (e.g., deactivates MAC 802 and activates MAC 804, or leaves MAC 802 active and activates MAC 804) to a second resolution mode. In this mode, an additional subset of hardware resources, such as MAC 804 and its associated input sub-registers (e.g., input sub-registers 812-816), multiplier circuits 822, 824, result registers 830, 832, and adder circuit 836, are enabled. This allows the system to perform a fine classification task, such as identifying sub-classes within the detected class. The results are again processed through the activation and quantization stages, and the quantized output 841 is updated accordingly.

In this regard, the NN manageability engine 140 controls transitions between the first and second resolution modes based on the completion status of the workload, ensuring that only the necessary hardware resources are active at any given time. This selective activation and deactivation of hardware resources enables dynamic resolution switching and ultra-low power operation of the NN circuit 800.

FIG. 9 depicts NN circuitry 900 configured to process data and identify classes and sub-classes at different resolutions and using different hardware configurations for a reduced set of processing hardware, according to an embodiment. Referring to FIG. 9, NN circuitry 900 includes memory 160, a plurality of input sub-registers 903 (including INT4 input sub-registers 904, 906, and 908), MAC 902 (including multiplier circuits 910 and 912, and adder circuit 918), result registers 914, 916, and 920, sigmoid function circuit 922, and quantization circuit 924.

In some aspects, MAC 902 can be configured to include circuits used during a first resolution mode (e.g., to perform a coarse classification task such as detecting an image class) in the core computation for the neural network layer, such as multiplier circuits 910 and 912, adder circuit 918, input sub-registers 904-908, and result registers 914, 916, and 920. Since NN circuitry 900 includes a single MAC 902, the same MAC 902 can be used for the first resolution mode and the second resolution mode (e.g., to perform a fine classification task such as detecting an image sub-class) in the core computation for the neural network layers

The memory 160 stores both the input data (such as feature vectors or the image data of FIG. 5 or FIG. 7) and the weights required for neural network computations. In some aspects, memory 160 is organized to provide 128 bytes of input data and 256 bytes of weight data per access, supporting data retrieval for each layer of the neural network.

Input sub-registers 904-908 are used to temporarily hold the input data and corresponding weights fetched from memory 160. Each of the input sub-registers is configured to store less than 8 bits of data (e.g., 4 bits of data), enabling parallel access to multiple data elements required for the subsequent computation.

Multiplier circuits 910-912 perform the core multiplication operations between the input data and the associated weights of the NN. These circuits are responsible for generating the products that form the basis of the neural network's weighted sum calculations.

Result registers 914 and 916 store the intermediate results produced by the multiplier circuits 910 and 912. These registers ensure that the products are available for further processing, such as accumulation and activation.

Adder circuit 918 receives the outputs from the result registers and performs the accumulation (addition) of the products. This operation generates the weighted sum used in the neural network layer computations.

Result register 920 holds the accumulated sum produced by the adder circuit 918. These values represent the pre-activation output of the neuron and are passed to the next stage for non-linear transformation.

The sigmoid function circuit 922 applies a non-linear activation function (such as a sigmoid) to the accumulated sum. This transformation introduces non-linearity into the neural network, enabling it to model complex relationships in the data. In some aspects, the sigmoid function circuit 922 detects whether the input from the result register 920 is higher than a threshold, which can be used to confirm a NN processing result (e.g., an image detection of a class or sub-class has occurred based on the threshold, and processing can be switched from coarse classification to fine classification performed by the same MAC 902).

Quantization circuit 924 reduces the bit-width of the activated output (e.g., 21 bits) to a desired resolution, such as 4 bits, to optimize storage and further processing. This operation can be used to ensure the quantized output 925 is compatible with subsequent layers of the NN or output interfaces.

The quantized output 925 represents the final processed result of the neural network layer, which can be used as the input to the next layer or as the final output for classification or regression tasks.

In some aspects, configuration parameter 926 can have the same functionalities and can be configured similarly to configuration parameter 842 of FIG. 8. Additionally, since NN circuitry 900 is configured with a single MAC 902, configuration parameter 926 can be used to switch between coarse and fine classification processing (e.g., when the quantized output 925 indicates a detected image class and completion of the coarse classification).

In some aspects, configuration parameter 926 can be configured to control transitions between the first resolution mode (coarse classification processing) and the second resolution mode (fine classification processing) based on a completion status of the workload being processed by NN circuitry 900.

In comparison to FIG. 8, where two separate MACs are used to perform the coarse and fine classification tasks, the configuration of FIG. 9 uses a single MAC for both classification tasks. In this regard, the configuration of FIG. 9 uses a smaller hardware footprint at the expense of extended processing time and efficiency (which is also illustrated in FIG. 11).

In some aspects, different power levels can be enabled or disabled in coordination with the selected operational mode. For example, when the system is operating in coarse resolution mode, the neural network management circuitry may place the device in low-power or ultra-low power mode by deactivating non-essential MACs, input sub-registers, or other hardware resources. As the system transitions to intermediate or fine resolution modes, additional circuits are powered up, moving the device into low-power or full-power mode as needed to support increased computational demands. The selection of power level is determined by the granularity of analysis required and the current workload, allowing the system to optimize energy usage while maintaining responsiveness.

In some aspects, the disclosed techniques and circuitry can include switching between operational and power modes. In some aspects, switching between different operational and power modes can occur automatically, based on real-time feedback from the neural network, telemetry data, or detection of specific events. For instance, upon detecting that a coarse resolution analysis has identified an area of interest or reached a predefined threshold, the system may automatically transition to a higher resolution mode and enable the corresponding power level. Alternatively, switching can be triggered by a schedule, such as periodic deep analysis at set intervals, or by user command, allowing manual control over the system's operational and power states. The neural network management circuitry orchestrates these transitions, ensuring that only the necessary hardware resources are active at any given time.

In some aspects, the disclosed techniques and circuitry can include using the same power level for different operational modes. In some embodiments, the same power level may be used for different operational modes to conserve energy at the cost of increased processing time. For example, the system may remain in low-power mode while performing both coarse and fine resolution tasks, sequentially reusing the same hardware resources (such as a single MAC) for multiple cycles. This approach reduces the overall hardware footprint and energy consumption, but may result in longer processing times for high-precision analysis. Such configurations are particularly advantageous in environments where power availability is limited, and real-time performance is less critical than energy efficiency.

These options provide a flexible framework for managing device power consumption in connection with multiple operational modes, supporting a wide range of use cases and deployment scenarios. By dynamically adjusting both the operational and power levels, the disclosed techniques and circuitry enable efficient, adaptive neural network processing across diverse applications and hardware platforms.

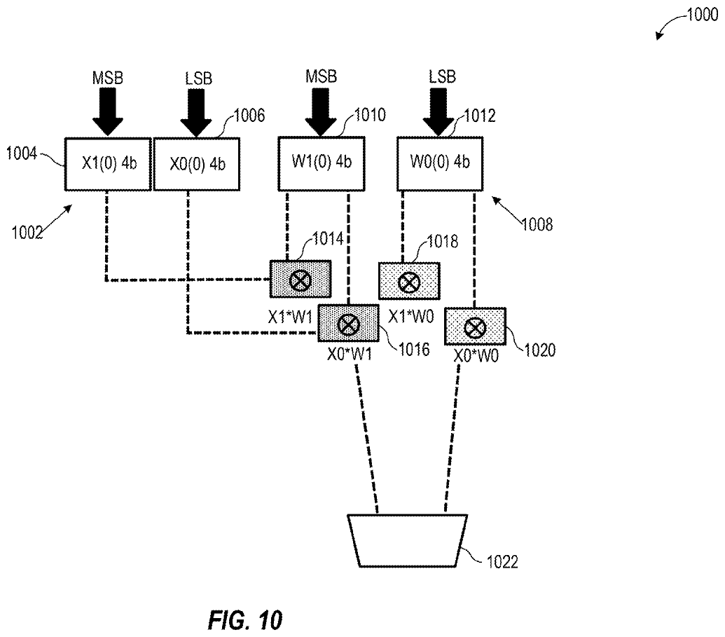

FIG. 10 depicts an example of basic building blocks of a multiplication-addition circuitry (MAC) 1000, which can be used in connection with the NN circuitry of FIG. 8 or FIG. 9, according to an embodiment. Referring to FIG. 10, MAC 1000 includes input register 1002 (comprising input sub-registers 1004 and 1006), input register 1008 (comprising input sub-registers 1010 and 1012), multiplier circuits 1014, 1016, 1018, and 1020, and adder circuit 1022.

Input sub-registers 1004 and 1006 are configured to store portions of the input data, such as the most significant bits (MSB) and least significant bits (LSB) of a given input value. These sub-registers are part of input register 1002, which stages the input data for processing.

Input sub-registers 1010 and 1012 are configured to store portions of the weight data, such as the MSB and LSB of a given weight value. These sub-registers are part of input register 1008, which stages the weight data for processing.

Multiplier circuits 1014, 1016, 1018, and 1020 perform multiplication operations between the input data and the weight data. Each multiplier circuit is responsible for computing the product of a specific combination of input and weight sub-registers. For example, multiplier circuit 1014 computes the product of the MSB of the input and the MSB of the weight, while multiplier circuit 1020 computes the product of the LSB of the input and the LSB of the weight.

Adder circuit 1022 is configured to accumulate the results of the various multiplier circuits. It sums the products generated by the multiplier circuits to produce the final weighted sum for the neural network computation.

In operation, input data is loaded into input register 1002, with the MSB and LSB distributed to input sub-registers 1004 and 1006, respectively. Similarly, weight data is loaded into input register 1008, with the MSB and LSB distributed to input sub-registers 1010 and 1012. The multiplier circuits 1014, 1016, 1018, and 1020 then compute the products of all possible combinations of input and weight sub-registers (e.g., X1W1, X0W1, X1W0, X0W0). The outputs of the multiplier circuits are then provided to the adder circuit 1022, which accumulates the results to generate the final sum.

FIG. 11 illustrates graphs of power consumption for the NN circuitries of FIG. 4, FIG. 8, and FIG. 9, according to an embodiment. Referring to FIG. 11, graph 1102 illustrates the power consumption of NN circuitry 400 of FIG. 4, graph 1104 illustrates the power consumption of NN circuitry 800 of FIG. 8, and graph 1106 illustrates the power consumption of NN circuitry 900 of FIG. 9.

Graph 1102 represents the power consumption profile of NN circuitry 400, which operates in a fixed fine resolution mode with full hardware operability (e.g., INT8 registers) throughout its execution. In this scenario, the power consumption remains constant at a high level across all time intervals (1 through 5), as the circuitry engages the full complement of hardware resources (e.g., INT8 registers and MACs) for each computation. It will be understood that this configuration does not incorporate any dynamic resolution switching or power-saving mechanisms, leading to consistently high power usage. As a result, graph 1102 serves as a baseline for comparison with the more advanced configurations depicted in graphs 1104 and 1106.

Graph 1104 illustrates the power consumption profile of NN circuitry 800, which supports dynamic resolution switching between coarse and fine resolution modes. During the initial time intervals (1 and 2), the circuitry operates in coarse resolution mode, utilizing a reduced subset of hardware resources (e.g., INT4 sub-registers of MAC 802) to perform basic classification tasks, thus reducing power consumption relative to fine resolution. At time interval 3, the circuitry transitions to fine resolution mode in response to a trigger—such as detection of a specific class—wherein additional hardware resources are activated (e.g., INT4 registers and MAC 804), leading to a temporary increase in power consumption. Following completion of the fine resolution task, the circuitry returns to coarse resolution mode at time interval 5, thereby reducing power consumption once again (e.g., deactivating MAC 804 and keeping MAC 802 as active). This dynamic switching mechanism is designed to improve overall power usage by engaging high-power resources only when necessary.

Graph 1106 depicts the power consumption profile of NN circuitry 900, which employs a compact hardware configuration with a single MAC that is reused across multiple cycles for fine-resolution tasks. In this implementation, the initial time intervals (1 and 2) mirror NN circuitry 900's coarse resolution mode with correspondingly low power consumption. At time interval 3, the circuitry transitions to fine resolution mode using the same MAC. Unlike NN circuitry 800, which activates additional hardware resources, NN circuitry 900 achieves fine resolution by performing multiple computation cycles (e.g., 3b,4, and 4b) using the same MAC. As a result, the increase in power consumption is moderate compared to coarse mode and remains lower than the peak consumption observed in NN circuitry 800. After completion of the fine resolution task, the circuitry returns to coarse resolution mode at time interval 5. This approach highlights a trade-off between power efficiency and computational performance.

FIG. 12 depicts a method 1200 for NN power configuration, according to an embodiment. In some aspects, method 1200 may be embodied in computer-readable instructions for execution by one or more hardware components (e.g., one or more processors) such that the operations of method 1200 may be performed by components of the compute platform 120, such as the NN manageability engine 140, or components of the data center 1300. Accordingly, method 1200 is described below, by way of example, with reference to the NN manageability engine 140. However, it should be noted that method 1200 may be deployed on various other hardware configurations and is not intended to be limited to deployment within the compute platform 120.

At operation 1210, the NN manageability engine 140 receives a configuration parameter (e.g., configuration parameter 842) associated with a workload of the neural network. This configuration parameter may be generated based on workload requirements, user input, or feedback from the neural network, and is used to determine the operational mode and resource allocation for the compute circuitry, such as the MACs and input sub-registers (e.g., as illustrated in FIG. 8).

At operation 1220, the NN manageability engine 140 selectively activates or deactivates a subset of the hardware resources of the compute circuitry based on the received configuration parameter. For example, the NN manageability engine 140 may enable only certain input sub-registers (e.g., 806, 808, 810) and associated multiplier circuits (e.g., 818, 820) within MAC 802, while deactivating other hardware resources to optimize power consumption.

At operation 1230, the NN manageability engine 140 configures the compute circuitry to operate in a first resolution mode by enabling a first subset of the hardware resources to perform a coarse classification task. In the context of FIG. 8, this may involve activating MAC 802 and its associated input sub-registers and result registers to process input data at a lower bit-width (e.g., INT4), allowing the system to efficiently perform basic class-level detection.

At operation 1240, the NN manageability engine 140 configures the compute circuitry to operate in a second resolution mode to perform a fine classification task, based on an outcome of the coarse classification task. Upon detecting that a specific class has been identified in the coarse mode, the management circuitry may activate additional hardware resources, such as MAC 804 and its associated input sub-registers (e.g., 812, 814, 816), to enable higher-precision processing for sub-class identification.

At operation 1250, the NN manageability engine 140 controls transitions between the first resolution mode and the second resolution mode based on a completion status of the workload. This includes monitoring the progress of the classification tasks and dynamically switching between coarse and fine resolution modes as needed, ensuring that only the necessary hardware resources are active at any given time to optimize both power efficiency and computational performance.

The described processing circuitry enables dynamic hardware reconfiguration in a neural network system, allowing for efficient power management and performance optimization. By selectively activating or deactivating subsets of hardware resources based on a configuration parameter, the system reduces power consumption during coarse classification tasks while maintaining the ability to perform fine-grained classification when needed. This approach physically reconfigures the hardware, such as disabling unused circuits, rather than relying solely on software-based adjustments, resulting in a more significant reduction in power usage.

The ability to transition between a first resolution mode (coarse classification) and a second resolution mode (fine classification) (or one or more other classification levels or resolution modes) ensures that computational resources are allocated only when necessary. For example, during coarse classification, only a minimal subset of hardware resources is utilized, which is sufficient to identify broad categories (e.g., detecting whether an image contains a human, animal, or car). Upon detecting the completion of this task, the system transitions to fine classification mode, activating additional hardware resources to perform detailed analysis, such as identifying specific subcategories (e.g., distinguishing between a baby, an artist, or an astronaut within the human category). This dynamic switching mechanism optimizes both power efficiency and computational precision.

The control of transitions between resolution modes based on workload completion status ensures that the system operates adaptively, responding to real-time processing demands. This feature is particularly advantageous in applications such as edge devices or IoT systems, where power efficiency is a significant consideration. For instance, in a surveillance camera system, the circuitry can remain in coarse resolution mode to monitor general activity and only switch to fine resolution mode when a specific trigger, such as detecting a human, is identified. This reduces unnecessary power consumption while maintaining high-resolution capabilities when required.

FIGS. 13, 14A, 14B, and 15 depict simplified aspects of example computing architectures in which any of the techniques and circuitry and configurations above may be implemented. It will be understood that the elements described above for chiplet composability may be integrated into various forms of the following hardware components.

FIG. 13 depicts an example hardware arrangement of a data center 1300 used to provide multiple implementations or instances of a computing system (e.g., a computing system 1500, discussed below), with each instance of the computing system being identified as a respective platform (e.g., platform 1330). The data center 1300 includes data center infrastructure 1301, a data center network fabric 1302, and a power distribution unit 1303 to support multiple racks of compute platforms, with a single instance of a rack 1310 depicted. The data center infrastructure 1301 may provide physical components that host the compute platform hardware, storage components, and networking equipment; the data center network fabric 1302 may include switches and networking components to support data flows among various compute platforms and storage devices throughout the data center, and the power distribution unit 1303 may include components to distribute and control power among the various compute platforms, networking, and storage devices.

The rack 1310 includes, but is not limited to cooling infrastructure 1311, a network interface 1312, and related physical components (not shown) to support discrete instances of multiple chassis. The rack 1310 provides power, connectivity, and cooling to each of the multiple chassis in a single rack, with a single instance of a chassis 1320 depicted in FIG. 13. The chassis 1320 includes, but is not limited to cooling infrastructure 1321, a chassis network fabric 1322, and a power supply 1323, which provides cooling, network connectivity, and power to multiple platforms within the chassis, with a single instance of a platform 1330 depicted in FIG. 13. It will be understood that a common data center rack configuration may include dozens of chassis, with each chassis adapted to support a number of platforms, depending on the physical size of the platform hardware and supporting equipment.

Platform 1330, in some implementations, may be referred to as a server or node, depending on the use case for the platform 1330 and a data center 1300. Platform 1330 includes, but is not limited to, the implementation of a discrete computing system hosted on a single board. Platform 1330 is depicted as hosting a chip assembly 1340A and a chip assembly 1340B on a first board provided by a printed circuitry board (PCB) or other platform board, shown as PCB 1331. In some examples, platform 1330 may include only one chip package. In contrast, PCB 1331 depicts the interconnection of multiple chip assemblies via a device-to-device interface (e.g., a PCI Express (PCIe) or Compute Express Link (CXL) interface). Additional chip packages and components (not shown) may also be hosted on the PCB 1331.

Some implementations of the chip assembly 1340A and 1340B may be termed as a System-on-Chip (SoC) package, as modular chiplets that perform different functions are integrated into a single package, even though this chip package is composed of multiple dies, unlike a traditional SoC design that uses a single die. Other implementations of the chip assembly 1340A and 1340B may be termed as a System-on-Package (SoP), System-in-a-Package (SiP), or similar references to a single chip package. Various combinations of 2D, 2.5D, and 3D packaging technologies may be used to manufacture and assemble the chip package and its underlying structure, and different manufacturing processes may be used to provide chiplets and components from different process nodes (e.g., semiconductor fabrication systems).

The chip assembly 1340A and chip assembly 1340B are packages that include multiple chiplets or dies for respective functions, such as separate chiplets for processing (e.g., CPU or GPU chiplets), memory (e.g., cache or high-bandwidth memory chiplets), I/O (e.g., I/O chiplets), acceleration (e.g., AI/ML acceleration chiplets), signal processing (e.g., audio or video processing chiplets), and the like. A close-up of the chip assembly 1340A is depicted as including an I/O Hub chiplet 1341, chiplets 1342, and a power supply 1343. These components may be hosted on an interposer that is designed to connect multiple dies or components within a single semiconductor package (e.g., chip package). In some examples, the chiplets 1342 may be manufactured and sourced separately and later assembled into the chip package to create the chip assembly 1340A. Various connections may be provided among the chiplets 1342, such as with the use of Universal Chiplet Interconnect Express (UCIe) or similar chiplet-to-chiplet interfaces and interconnects (e.g., Advanced Interface Bus (AIB), Bunch of Wires (BoW), etc.), or between chiplets and on-chip memory (e.g., high-bandwidth memory (HBM)) using HBM3 (JEDEC), Universal Memory Interface (UMI), or other memory interfaces. Similar interfaces and interconnects may be used for chip-to-chip or die-to-die communications (e.g., using NVIDIA® NVLink-C2C, Cache Coherent Interconnect for Accelerators (CIX), Compute Express Link (CXL), Advanced eXtensible Interface (AXI), and specific implementations of PCIe, CXL, etc.).

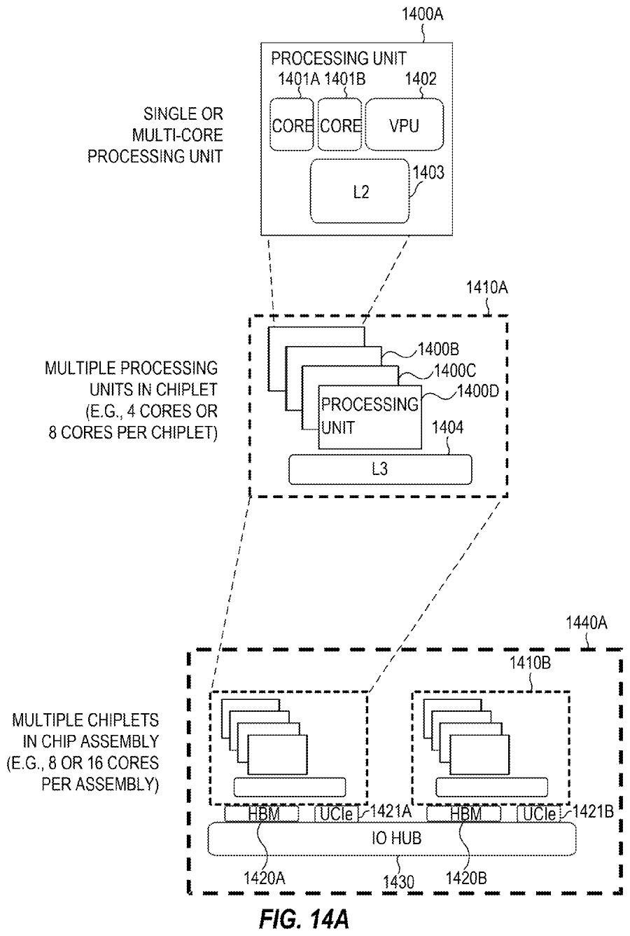

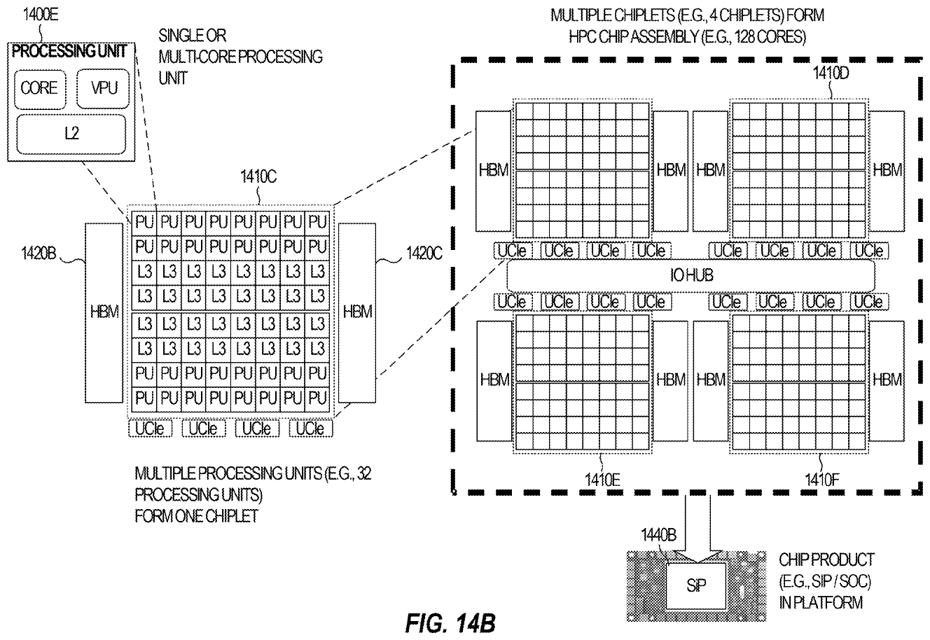

FIG. 14A depicts an example arrangement of a chip assembly 1440A (e.g., a multi-processing core implementation of chip assembly 1340A or 1340B), with expanded views of the chiplets and processing units included therein. This arrangement shows how the chip assembly 1440A, which may constitute a SoC, SoP, SiP, or other type of chip package, is composed of chiplets such as chiplet 1410A, chiplet 1410B, etc., and associated on-package memory (e.g., high-speed memory) such as 3D-stacked HBM instances shown as HBM 1420A, HBM 1420B, interfaces (e.g., UCIe interfaces) shown as UCIe 1421A, UCIe 1421B, and I/O hub 1430 (e.g., which may be implemented by an I/O chiplet). Other hardware elements of a chip package are not depicted for simplicity.

Each chiplet includes multiple processing units, and each processing unit includes one or multiple cores. For instance, chiplet 1410A, as depicted, includes four processing units (processing unit 1400A, processing unit 1400B, processing unit 1400C, and the processing unit 1400D) and an L3 cache 1404. Each processing unit may include one or multiple processing cores, one or multiple caches, and, optionally, other processing units or elements. For instance, a processing unit 1400A is depicted as including two cores (core 1401A and core 1401B), vector processing unit 1402, and an L2 cache 1403. Accordingly, a single-core processing unit arrangement can provide 4 cores per chiplet and 8 total cores in a two-chiplet chip assembly, whereas a dual-core processing unit arrangement can provide 8 cores per chiplet and 16 total cores in a two-chiplet chip assembly. Other permutations may also be provided. A variety of signaling interfaces and protocols (not shown) may be used for core-to-core and inter-processor communications, including but not limited to the use of coherency protocols, mesh, ring, or hybrid ring-mesh interconnects, Network-on-Chip (NoC), and packet-switched communications and the like.

FIG. 14B depicts an example arrangement of a chip assembly 1440B (e.g., a multi-chiplet high-performance computing (HPC) implementation of chip assembly 1340A, 1340B), adapted for HPC applications (e.g., parallel processing operations involving thousands, millions, or more processors or cores operating simultaneously). The example chip assembly 1440B depicts placement as a SiP, SoC, or other package onto a platform board (e.g., PCB 1331) and optionally in a data center (e.g., data center 1300) or in a standalone deployment setting (e.g., in a standalone computer system, mobile computing device, autonomous device, etc.).

The chip assembly 1440B is composed of multiple chiplets, shown with four chiplets: chiplet 1410C, chiplet 1410D, chiplet 1410E, and chiplet 1410F. Each chiplet includes multiple processing units, such as 32 processing units with a corresponding L3 cache for each processing unit. Each processing unit may include one or multiple cores, such as a single-core processing unit 1400E shown as part of the chiplet 1410C. The chip assembly 1440B is also composed of corresponding memory resources, such as HBM elements corresponding to respective banks of processing units (e.g., HBM 1420B and HBM 1420C corresponding to respective sets of processing units of chiplet 1410C), UCIe interfaces, and an IO Hub.

The chip assembly and related products or devices described herein may be configured in a variety of computing system implementations. Such implementations include machine-readable non-transitory media storing machine-readable instructions and one or more processors coupled to the memory, such that executing the machine-readable instructions configures the computing system and implements hardware (e.g., the processing unit 1400, chiplet 1410, chip 1340, platform 1330) to perform steps and operations described above for electronic systems or devices (e.g., to perform chiplet composability, etc.). It should be further understood that software, including one or more computer-executable instructions that facilitate processing and operations as described above, may be distributed, installed, or otherwise provided with networked devices (e.g., servers or cloud computing systems). Alternatively, in some examples, the software may be obtained and loaded (or re-loaded/upgraded) from one or more servers and/or cloud computing systems, such as software stored on a server for distribution over the Internet, for example.

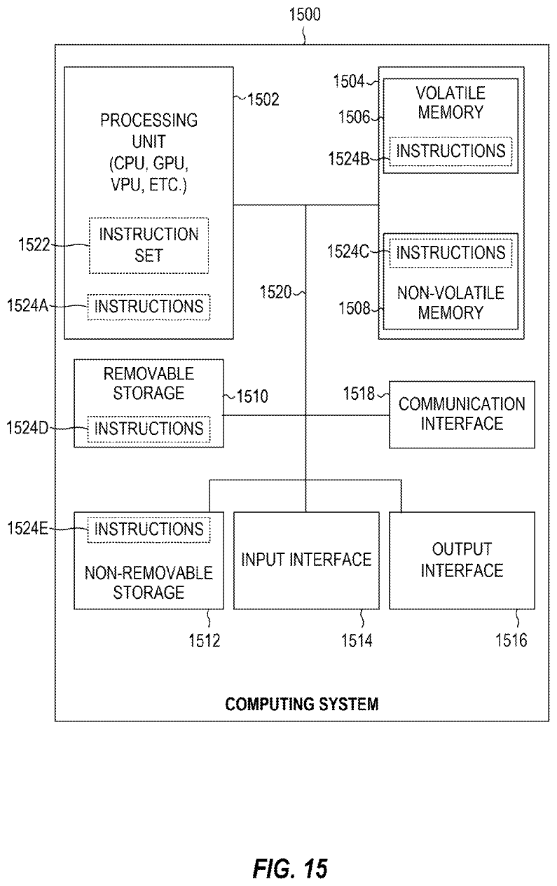

FIG. 15 depicts a block diagram of an example computing system 1500 (e.g., device, apparatus, machine, etc.) that may be programmed into a special purpose machine suitable for implementing one or more embodiments for chiplet composability and like aspects disclosed herein. For instance, the chiplets, interconnect platforms, or other components described above may be embodied by the computing system 1500, such as in the form of a computer or specialized electronic device that includes sufficient processing power, memory resources, and communications throughput capability to perform operations consistent with the examples herein.

The computing system 1500 may include at least one hardware processing unit 1502, such as a central processing unit (CPU), a graphics processing unit (GPU), a vector processing unit (VPU), a neural processing unit (NPU), a hardware accelerator, or combinations or variants thereof. The at least one hardware processing unit 1502 is an implementation of processor circuitry and may be embodied by various types of chip assemblies, products, or packages, as discussed with reference to FIGS. 13 to 14B. Circuitry (e.g., processing circuitry), as used herein, is a collection of circuits implemented in tangible entities of the computing system 1500 that includes hardware (e.g., simple circuits, gates, logic, etc.). Circuitry membership may be flexible over time. Circuitries include members that may, alone or in combination, perform specified operations when operating. In some examples, the hardware of the circuitry may be immutably designed to carry out a specific operation (e.g., hardwired).

In an example, the hardware of the circuitry may include variably connected physical components (e.g., execution units, transistors, simple circuits, etc.), including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of a first circuitry at one point in time and reused by a second circuit in the first circuitry or by a third circuit in a second circuitry at a different time.

The computing system 1500 may also include at least one memory device 1504, such as volatile memory 1506 and non-volatile memory 1508, and at least one storage device, such as removable storage 1510 and/or non-removable storage 1512, such as a drive unit, some or all of which may communicate with each other via an interconnect, fabric, link, or bus 1520.

The computing system 1500 may include an output interface 1516, such as an interface connected to a display device and an input interface 1514, such as an interface connected to an alphanumeric input device or a user interface (UI) navigation device. In some examples, a connected I/O device may also include a display device, an alphanumeric input device, and a navigation device that is integrated into a single unit, such as a touchscreen display.

The computing system 1500 may additionally include a communication interface 1518, such as for connection with a network interface device used to transmit and receive electronic signals on a network. The computing system 1500 may also include other interfaces or hardware (not shown) in connection with a signal generation device (e.g., an audio or radio signal generation device), an output controller (e.g., for connection with a serial, universal serial bus (USB), parallel, or other wired or wireless connection such as which uses via infrared (IR) or near field communication (NFC) technologies), an input controller (e.g., for connection with sensors or peripheral devices), and the like.

Any of the memory or storage devices, such as the volatile memory 1506, the non-volatile memory 1508, the removable storage 1510, or the non-removable storage 1512 may provide a machine-readable medium. Some examples of a machine-readable medium are a non-transitory medium that hosts or stores one or more sets of data structures or instructions (e.g., software instructions) embodying or utilized by any one or more of the techniques and circuitry or functions described herein. Such instructions are collectively labeled as instructions 1524 with respective implementations of instructions 1524A, 1524B, 1524C, 1524D, and 1524E.

The instructions 1524 may reside, during execution or other operation of the computing system 1500, entirely or at least partially within the volatile memory 1506 as instructions 1524B, within non-volatile memory 1508 as instructions 1524C, within removable storage as instructions 1524D, within non-removable storage as instructions 1524E, or within the hardware processing unit 1502 as instructions 1524A. Thus, any combination of the hardware processing unit 1502, the volatile memory 1506, the non-volatile memory 1508, or a storage device of the removable storage 1510 or non-removable storage 1512 may constitute a machine-readable medium or media. The instructions 1524A, when loaded and executed by the hardware processing unit 1502, may invoke or utilize a defined instruction set 1522 of the hardware processing unit 1502, such as a processor instruction set defined by an instruction set architecture (ISA) of a reduced instruction set computer (RISC) or complex instruction set computer (CISC) architecture—including but not limited to the RISC-V Instruction Set provided in a RISC-V architecture. It will be understood that a RISC-V architecture and instruction set is one of several available architectures and instruction sets that may be used in implementations of the functional compute components (e.g., the hardware processing unit 1502) discussed herein.

The term “machine-readable medium” may include any medium that is capable of storing, encoding, or carrying instructions for execution by components or the whole of the computing system 1500 (or a similar machine) that causes the computing system 1500 or its components to perform any one or more of the techniques and circuitry or functions described herein, or that is capable of storing, encoding, or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; and optical or magneto-optical disks.

The instructions 1524 may further be transmitted or received over a communications network using a transmission medium via the communication interface 1518 and related devices utilizing any one of a number of transfer protocols (e.g., frame relay, Internet Protocol (IP), Transmission Control Protocol (TCP), User Datagram Protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®), IEEE 802.15.4 family of standards, peer-to-peer (P2P) networks, among others.

Method examples or other operations described herein can be implemented in part or in whole by the aforementioned machines, platforms, devices, or related systems (including computer, robotic, and autonomous systems). The components of the illustrative devices, systems, and methods employed may be implemented in various examples by digital electronic circuitry, analog electronic circuitry, or in computer hardware, firmware, software, or combinations of them. These components may be implemented, for example, as a computing program product such as a computing program, program code, or computer instructions tangibly embodied in an information carrier or a machine-readable storage device, for execution by, or to control the operation of, a data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. Also, functional programs, codes, and code segments for accomplishing the techniques and circuitry described herein may be easily construed as within the scope of the present disclosure by programmers skilled in the art.

Method steps associated with the illustrative embodiments may be performed by processing circuitry executing a computing program, code, or instructions to perform operations or functions (e.g., by operating on input data and/or generating an output). Further, such operations or functions may be embodied by a machine-readable medium, which is capable of storing instructions for execution by processing circuitry (including the specific processing unit examples discussed herein), such that the instructions, when executed by the processing circuitry, cause the processing circuitry to perform any one or more of the methodologies described herein.
Example 1 is processing circuitry, comprising: compute circuitry, the compute circuitry comprising hardware resources to perform compute operations of a neural network configured in a computing platform; and neural network management circuitry to: receive a configuration parameter associated with a workload of the neural network; selectively activate or deactivate a subset of the hardware resources of the compute circuitry based on the configuration parameter; configure the compute circuitry to operate in a first resolution mode by enabling a first subset of the hardware resources to perform a coarse classification task; configure the compute circuitry to operate in a second resolution mode to perform a fine classification task, based on an outcome of the coarse classification task; and control transitions between the first resolution mode and the second resolution mode based on a completion status of the workload.
In Example 2, the subject matter of Example 1 includes functionalities such as, wherein the hardware resources comprise at least one multiplication-addition circuit (MAC) and associated input registers, and wherein the neural network management circuitry is to: configure the compute circuitry to operate in the first resolution mode by enabling a first plurality of input sub-registers of the input registers as the first subset of the hardware resources.
In Example 3, the subject matter of Example 2 includes functionalities such as, wherein the neural network management circuitry is to: configure the compute circuitry to operate in the second resolution mode by enabling a second plurality of input sub-registers of the input registers as a second subset of the hardware resources to perform a fine classification task.
In Example 4, the subject matter of Examples 2-3 includes functionalities such as, wherein the neural network management circuitry is to: configure the compute circuitry to operate in the second resolution mode by reusing the first plurality of input sub-registers of the input registers for the fine classification task.
In Example 5, the subject matter of Examples 1-4 includes functionalities such as, wherein the neural network management circuitry is to: generate the configuration parameter based on a quantized output of the neural network indicating a detection of a specific class.
In Example 6, the subject matter of Examples 1-5 includes functionalities such as, wherein the hardware resources comprise a plurality of multiplication-addition circuits (MACs), and wherein the neural network management circuitry is to: deactivate at least one MAC of the plurality of MACs during the first resolution mode, and activate the at least one MAC during the second resolution mode.
In Example 7, the subject matter of Examples 1-6 includes functionalities such as, wherein the hardware resources comprise a plurality of input sub-registers, each configured to store less than 8 bits of data.
In Example 8, the subject matter of Examples 1-7 includes functionalities such as, wherein the neural network management circuitry is to: receive telemetry data from the compute circuitry, the telemetry data indicating at least a utilization rate of the hardware resources; and selectively activate or deactivate the subset of the hardware resources via the configuration parameter, based on the utilization rate of the hardware resources.
In Example 9, the subject matter of Example 8 includes functionalities such as, wherein the neural network management circuitry is to: perform an automatic wake-up by transitioning from the first resolution mode to the second resolution mode in response to a trigger condition detected by the neural network.
In Example 10, the subject matter of Example 9 includes functionalities such as, wherein the trigger condition is based on at least one of: the completion status of the workload; and the telemetry data exceeding a pre-configured value.
In Example 11, the subject matter of Examples 1-10 includes functionalities such as, wherein the hardware resources comprise a plurality of result registers, and wherein the neural network management circuitry is to: selectively activate or deactivate the plurality of result registers based on the configuration parameter.
In Example 12, the subject matter of Example 11 includes functionalities such as, wherein the neural network management circuitry is to: selectively activate or deactivate sub-registers of the plurality of result registers based on the configuration parameter.
In Example 13, the subject matter of Examples 1-12 includes functionalities such as, wherein the neural network management circuitry is to: control a sigmoid function circuit to apply a non-linear activation function to an accumulated sum in both the first and second resolution modes.
In Example 14, the subject matter of Examples 1-13 includes functionalities such as, wherein the neural network management circuitry is to: operate the compute circuitry based on powering down or disconnecting at least a portion of the hardware resources during the first resolution mode.
In Example 15, the subject matter of Examples 1-14 includes functionalities such as, wherein the workload comprises image data associated with a class and a sub-class, and wherein: to perform the coarse classification task, the neural network management circuitry is to: configure the first subset of the hardware resources to detect the class of the image data; and to perform the fine classification task, the neural network management circuitry is to: configure a second subset of the hardware resources to detect the sub-class of the image data.
In Example 16, the subject matter of Examples 1-15 includes functionalities such as, wherein the hardware resources include a plurality of processor cores, and wherein the configuration parameter is further based on at least one of: performance states, power states, or energy states, of at least one of the plurality of processor cores or memory resources of the compute circuitry.
In Example 17, the subject matter of Example 16 includes functionalities such as, wherein the processing circuitry is a multi-chiplet package, wherein the compute circuitry includes at least one processor chiplet, and wherein the neural network management circuitry includes a chiplet separate from the at least one processor chiplet.
In Example 18, the subject matter of Examples 1-17 includes functionalities such as, wherein the neural network management circuitry is further configured to: support more than two resolution modes, including at least one intermediate resolution mode between the first and second resolution modes, by selectively activating or deactivating additional subsets of the hardware resources to provide varying levels of granularity in classification tasks.
In Example 19, the subject matter of Example 18 includes functionalities such as, wherein the neural network management circuitry is further configured to: dynamically transition between two resolution modes of the more than two resolution modes.
In Example 20, the subject matter of Examples 18-19 includes functionalities such as, wherein to perform the transition, the neural network management circuitry is further configured to: skip the at least one intermediate resolution mode and transition from a coarse resolution mode to a fine resolution mode, or vice versa, based on the configuration parameter or detected workload conditions.
In Example 21, the subject matter of Examples 4-20 includes functionalities such as, wherein the neural network management circuitry is further configured to, during operation in the first resolution mode, enable a portion of the input registers or the hardware resources for the coarse classification task, and deactivate or power down remaining unused portions of registers of the input registers or the hardware resources.
In Example 22, the subject matter of Examples 8-21 includes functionalities such as, wherein deactivation of the subset of hardware resources by the neural network management circuitry comprises placing a deactivated portion of the hardware resources into at least a lower power mode or a no power mode, or reallocating the deactivated portion of the hardware resources for use in other functions within the compute circuitry.
In Example 23, the subject matter of Examples 1-22 includes functionalities such as, wherein the neural network management circuitry is configured to process a workload comprising any of image data, audio data, sensor data, time-series data, or network traffic data.
Example 24 is a machine-readable medium including instructions, which when executed by processing circuitry, configures the processing circuitry according to any of Examples 1 to 23.
Example 25 is a method for telemetry monitoring, comprising operations to configure the processing circuitry according to any of Examples 1 to 23.
Example 26 is a method for configuring a neural network (NN), comprising: receiving, by at least one hardware processor, a configuration parameter associated with a workload of the neural network; selectively activating or deactivating a subset of hardware resources of compute circuitry based on the configuration parameter; configuring the compute circuitry to operate in a first resolution mode by enabling a first subset of the hardware resources to perform a coarse classification task; configuring the compute circuitry to operate in a second resolution mode to perform a fine classification task, based on an outcome of the coarse classification task; and controlling transitions between the first resolution mode and the second resolution mode based on a completion status of the workload.
In Example 27, the subject matter of Example 26 includes functionalities such as, wherein the hardware resources comprise at least one multiplication-addition circuit (MAC) and associated input registers, and wherein configuring the compute circuitry to operate in the first resolution mode comprises enabling a first plurality of input sub-registers of the input registers as the first subset of the hardware resources.
In Example 28, the subject matter of Example 27 includes functionalities such as, further comprising configuring the compute circuitry to operate in the second resolution mode by enabling a second plurality of input sub-registers of the input registers as a second subset of the hardware resources to perform a fine classification task.
In Example 29, the subject matter of Examples 27-28 includes functionalities such as, further comprising configuring the compute circuitry to operate in the second resolution mode by reusing the first plurality of input sub-registers of the input registers for the fine classification task.
In Example 30, the subject matter of Examples 26-29 includes functionalities such as, further comprising generating the configuration parameter based on a quantized output of the neural network indicating a detection of a specific class.
In Example 31, the subject matter of Examples 26-30 includes functionalities such as, wherein the hardware resources comprise a plurality of multiplication-addition circuits (MACs), and further comprising deactivating at least one MAC of the plurality of MACs during the first resolution mode, and activating the at least one MAC during the second resolution mode.
In Example 32, the subject matter of Examples 26-31 includes functionalities such as, wherein the hardware resources comprise a plurality of input sub-registers, each configured to store less than 8 bits of data.
In Example 33, the subject matter of Examples 26-32 includes functionalities such as, further comprising: receiving telemetry data from the compute circuitry, the telemetry data indicating at least a utilization rate of the hardware resources; and selectively activating or deactivating the subset of the hardware resources via the configuration parameter, based on the utilization rate of the hardware resources.
In Example 34, the subject matter of Example 33 includes functionalities such as, further comprising performing an automatic wake-up by transitioning from the first resolution mode to the second resolution mode in response to a trigger condition detected by the neural network.
In Example 35, the subject matter of Example 34 includes functionalities such as, wherein the trigger condition is based on at least one of: the completion status of the workload; and the telemetry data exceeding a pre-configured value.
In Example 36, the subject matter of Examples 26-35 includes functionalities such as, wherein the hardware resources comprise a plurality of result registers, and further comprising selectively activating or deactivating the plurality of result registers based on the configuration parameter.
In Example 37, the subject matter of Example 36 includes functionalities such as, further comprising selectively activating or deactivating sub-registers of the plurality of result registers based on the configuration parameter.
In Example 38, the subject matter of Examples 26-37 includes functionalities such as, further comprising controlling a sigmoid function circuit to apply a non-linear activation function to an accumulated sum in both the first and second resolution modes.
In Example 39, the subject matter of Examples 26-38 includes functionalities such as, further comprising operating the compute circuitry based on powering down or disconnecting at least a portion of the hardware resources during the first resolution mode.
In Example 40, the subject matter of Examples 26-39 includes functionalities such as, wherein the workload comprises image data associated with a class and a sub-class, and wherein: to perform the coarse classification task, the method comprises configuring the first subset of the hardware resources to detect the class of the image data; and to perform the fine classification task, the method comprises configuring a second subset of the hardware resources to detect the sub-class of the image data.
In Example 41, the subject matter of Examples 26-40 includes functionalities such as, wherein the hardware resources include a plurality of processor cores, and wherein the configuration parameter is further based on at least one of: performance states, power states, or energy states, of at least one of the plurality of processor cores or memory resources of the compute circuitry.
In Example 42, the subject matter of Example 41 includes functionalities such as, wherein the compute circuitry is a multi-chiplet package, wherein the compute circuitry includes at least one processor chiplet, and wherein the neural network management circuitry includes a chiplet separate from the at least one processor chiplet.
In Example 43, the subject matter of Examples 26-42 includes functionalities such as, further comprising supporting more than two resolution modes, including at least one intermediate resolution mode between the first and second resolution modes, by selectively activating or deactivating additional subsets of the hardware resources to provide varying levels of granularity in classification tasks.
In Example 44, the subject matter of Example 43 includes functionalities such as, further comprising dynamically transitioning between two resolution modes of the more than two resolution modes.
In Example 45, the subject matter of Examples 43-44 includes functionalities such as, further comprising skipping the at least one intermediate resolution mode and transitioning directly from a coarse resolution mode to a fine resolution mode, or vice versa, based on the configuration parameter or detected workload conditions.
In Example 46, the subject matter of Examples 29-45 includes functionalities such as, further comprising, during operation in the first resolution mode, enabling a portion of the input registers or the hardware resources for the coarse classification task, and deactivating or powering down remaining unused portions of registers of the input registers or the hardware resources.
In Example 47, the subject matter of Examples 33-46 includes functionalities such as, wherein deactivation of the subset of hardware resources comprises placing a deactivated portion of the hardware resources into at least a lower power mode or a no power mode, or reallocating the deactivated portion of the hardware resources for use in other functions within the compute circuitry.
In Example 48, the subject matter of Examples 26-47 includes functionalities such as, wherein the neural network management circuitry is configured to process a workload comprising any of image data, audio data, sensor data, time-series data, or network traffic data.
Example 49 is a computer-readable storage medium that stores instructions for execution by one or more processors of a computing device, the instructions to cause the computing device to perform operations comprising: receiving a configuration parameter associated with a workload of a neural network; selectively activating or deactivating a subset of hardware resources of compute circuitry based on the configuration parameter; configuring the compute circuitry to operate in a first resolution mode by enabling a first subset of the hardware resources to perform a coarse classification task; configuring the compute circuitry to operate in a second resolution mode to perform a fine classification task, based on an outcome of the coarse classification task; and controlling transitions between the first resolution mode and the second resolution mode based on a completion status of the workload.
In Example 50, the subject matter of Example 49 includes functionalities such as, wherein the hardware resources comprise at least one multiplication-addition circuit (MAC) and associated input registers, and the instructions further cause the computing device to enable a first plurality of input sub-registers of the input registers as the first subset of the hardware resources in the first resolution mode.
In Example 51, the subject matter of Example 50 includes functionalities such as, wherein the instructions further cause the computing device to configure the compute circuitry to operate in the second resolution mode by enabling a second plurality of input sub-registers of the input registers as a second subset of the hardware resources to perform a fine classification task.
In Example 52, the subject matter of Examples 50-51 includes functionalities such as, wherein the instructions further cause the computing device to configure the compute circuitry to operate in the second resolution mode by reusing the first plurality of input sub-registers of the input registers for the fine classification task.
In Example 53, the subject matter of Examples 49-52 includes functionalities such as, wherein the instructions further cause the computing device to generate the configuration parameter based on a quantized output of the neural network indicating a detection of a specific class.
In Example 54, the subject matter of Examples 49-53 includes functionalities such as, wherein the hardware resources comprise a plurality of multiplication-addition circuits (MACs), and the instructions further cause the computing device to deactivate at least one MAC of the plurality of MACs during the first resolution mode and activate the at least one MAC during the second resolution mode.
In Example 55, the subject matter of Examples 49-54 includes functionalities such as, wherein the hardware resources comprise a plurality of input sub-registers, each configured to store less than 8 bits of data.
In Example 56, the subject matter of Examples 49-55 includes functionalities such as, wherein the instructions further cause the computing device to: receive telemetry data from the compute circuitry, the telemetry data indicating at least a utilization rate of the hardware resources; and selectively activate or deactivate the subset of the hardware resources via the configuration parameter, based on the utilization rate of the hardware resources.
In Example 57, the subject matter of Example 56 includes functionalities such as, wherein the instructions further cause the computing device to perform an automatic wake-up by transitioning from the first resolution mode to the second resolution mode in response to a trigger condition detected by the neural network.
In Example 58, the subject matter of Example 57 includes functionalities such as, wherein the trigger condition is based on at least one of: the completion status of the workload; and the telemetry data exceeding a pre-configured value.
In Example 59, the subject matter of Examples 49-58 includes functionalities such as, wherein the hardware resources comprise a plurality of result registers, and the instructions further cause the computing device to selectively activate or deactivate the plurality of result registers based on the configuration parameter.
In Example 60, the subject matter of Example 59 includes functionalities such as, wherein the instructions further cause the computing device to selectively activate or deactivate sub-registers of the plurality of result registers based on the configuration parameter.
In Example 61, the subject matter of Examples 49-60 includes functionalities such as, wherein the instructions further cause the computing device to control a sigmoid function circuit to apply a non-linear activation function to an accumulated sum in both the first and second resolution modes.
In Example 62, the subject matter of Examples 49-61 includes functionalities such as, wherein the instructions further cause the computing device to operate the compute circuitry based on powering down or disconnecting at least a portion of the hardware resources during the first resolution mode.
In Example 63, the subject matter of Examples 49-62 includes functionalities such as, wherein the workload comprises image data associated with a class and a sub-class, and wherein: to perform the coarse classification task, the instructions cause the computing device to configure the first subset of the hardware resources to detect the class of the image data; and to perform the fine classification task, the instructions cause the computing device to configure a second subset of the hardware resources to detect the sub-class of the image data.
In Example 64, the subject matter of Examples 49-63 includes functionalities such as, wherein the hardware resources include a plurality of processor cores, and the configuration parameter is further based on at least one of: performance states, power states, or energy states, of at least one of the plurality of processor cores or memory resources of the compute circuitry.
In Example 65, the subject matter of Example 64 includes functionalities such as, wherein the compute circuitry is a multi-chiplet package, wherein the compute circuitry includes at least one processor chiplet, and the neural network management circuitry includes a chiplet separate from the at least one processor chiplet.
In Example 66, the subject matter of Examples 49-65 includes functionalities such as, wherein the instructions further cause the computing device to support more than two resolution modes, including at least one intermediate resolution mode between the first and second resolution modes, by selectively activating or deactivating additional subsets of the hardware resources to provide varying levels of granularity in classification tasks.
In Example 67, the subject matter of Example 66 includes functionalities such as, wherein the instructions further cause the computing device to dynamically transition between two resolution modes of the more than two resolution modes.
In Example 68, the subject matter of Examples 66-67 includes functionalities such as, wherein the instructions further cause the computing device to skip the at least one intermediate resolution mode and transition directly from a coarse resolution mode to a fine resolution mode, or vice versa, based on the configuration parameter or detected workload conditions.
In Example 69, the subject matter of Examples 52-68 includes functionalities such as, wherein the instructions further cause the computing device, during operation in the first resolution mode, to enable a portion of the input registers or the hardware resources for the coarse classification task, and deactivate or power down remaining unused portions of registers of the input registers or the hardware resources.
In Example 70, the subject matter of Examples 56-69 includes functionalities such as, wherein the instructions further cause the computing device to place a deactivated portion of the hardware resources into at least a lower power mode or a no power mode, or reallocate the deactivated portion of the hardware resources for use in other functions within the compute circuitry.
In Example 71, the subject matter of Examples 49-70 includes functionalities such as, wherein the instructions further cause the computing device to process a workload comprising any of image data, audio data, sensor data, time-series data, or network traffic data.
Example 72 is an apparatus comprising: means for receiving a configuration parameter associated with a workload of a neural network; means for selectively activating or deactivating a subset of hardware resources of compute circuitry based on the configuration parameter; means for configuring the compute circuitry to operate in a first resolution mode by enabling a first subset of the hardware resources to perform a coarse classification task; means for configuring the compute circuitry to operate in a second resolution mode to perform a fine classification task, based on an outcome of the coarse classification task; and means for controlling transitions between the first resolution mode and the second resolution mode based on a completion status of the workload.
In Example 73, the subject matter of Example 72 includes functionalities such as, wherein the hardware resources comprise at least one multiplication-addition circuit (MAC) and associated input registers, and further comprising: means for configuring the compute circuitry to operate in the first resolution mode by enabling a first plurality of input sub-registers of the input registers as the first subset of the hardware resources.
In Example 74, the subject matter of Example 73 includes functionalities such as, further comprising: means for configuring the compute circuitry to operate in the second resolution mode by enabling a second plurality of input sub-registers of the input registers as a second subset of the hardware resources to perform a fine classification task.
In Example 75, the subject matter of Examples 73-74 includes functionalities such as, further comprising: means for configuring the compute circuitry to operate in the second resolution mode by reusing the first plurality of input sub-registers of the input registers for the fine classification task.
In Example 76, the subject matter of Examples 72-75 includes functionalities such as, further comprising: means for generating the configuration parameter based on a quantized output of the neural network indicating a detection of a specific class.
In Example 77, the subject matter of Examples 72-76 includes functionalities such as, wherein the hardware resources comprise a plurality of multiplication-addition circuits (MACs), and further comprising: means for deactivating at least one MAC of the plurality of MACs during the first resolution mode, and activating the at least one MAC during the second resolution mode.
In Example 78, the subject matter of Examples 72-77 includes functionalities such as, wherein the hardware resources comprise a plurality of input sub-registers, each configured to store less than 8 bits of data.
In Example 79, the subject matter of Examples 72-78 includes functionalities such as, further comprising: means for receiving telemetry data from the compute circuitry, the telemetry data indicating at least a utilization rate of the hardware resources; and means for selectively activating or deactivating the subset of the hardware resources via the configuration parameter, based on the utilization rate of the hardware resources.
In Example 80, the subject matter of Example 79 includes functionalities such as, further comprising: means for performing an automatic wake-up by transitioning from the first resolution mode to the second resolution mode in response to a trigger condition detected by the neural network.
In Example 81, the subject matter of Example 80 includes functionalities such as, wherein the trigger condition is based on at least one of: the completion status of the workload; and the telemetry data exceeding a pre-configured value.
In Example 82, the subject matter of Examples 72-81 includes functionalities such as, wherein the hardware resources comprise a plurality of result registers, and further comprising: means for selectively activating or deactivating the plurality of result registers based on the configuration parameter.
In Example 83, the subject matter of Example 82 includes functionalities such as, further comprising: means for selectively activating or deactivating sub-registers of the plurality of result registers based on the configuration parameter.
In Example 84, the subject matter of Examples 72-83 includes functionalities such as, further comprising: means for controlling a sigmoid function circuit to apply a non-linear activation function to an accumulated sum in both the first and second resolution modes.
In Example 85, the subject matter of Examples 72-84 includes functionalities such as, further comprising: means for operating the compute circuitry based on powering down or disconnecting at least a portion of the hardware resources during the first resolution mode.
In Example 86, the subject matter of Examples 72-85 includes functionalities such as, wherein the workload comprises image data associated with a class and a sub-class, and further comprising: means for configuring the first subset of the hardware resources to detect the class of the image data to perform the coarse classification task; and means for configuring a second subset of the hardware resources to detect the sub-class of the image data to perform the fine classification task.
In Example 87, the subject matter of Examples 72-86 includes functionalities such as, wherein the hardware resources include a plurality of processor cores, and wherein the configuration parameter is further based on at least one of: performance states, power states, or energy states, of at least one of the plurality of processor cores or memory resources of the compute circuitry.
In Example 88, the subject matter of Example 87 includes functionalities such as, wherein the compute circuitry is a multi-chiplet package, wherein the compute circuitry includes at least one processor chiplet, and wherein the neural network management circuitry includes a chiplet separate from the at least one processor chiplet.
In Example 89, the subject matter of Examples 72-88 includes functionalities such as, further comprising: means for supporting more than two resolution modes, including at least one intermediate resolution mode between the first and second resolution modes, by selectively activating or deactivating additional subsets of the hardware resources to provide varying levels of granularity in classification tasks.
In Example 90, the subject matter of Example 89 includes functionalities such as, further comprising: means for dynamically transitioning between two resolution modes of the more than two resolution modes.
In Example 91, the subject matter of Examples 89-90 includes functionalities such as, further comprising: means for skipping the at least one intermediate resolution mode and transitioning directly from a coarse resolution mode to a fine resolution mode, or vice versa, based on the configuration parameter or detected workload conditions.
In Example 92, the subject matter of Examples 75-91 includes functionalities such as, further comprising: means for enabling a portion of the input registers or the hardware resources for the coarse classification task during operation in the first resolution mode, and means for deactivating or powering down remaining unused portions of registers of the input registers or the hardware resources.
In Example 93, the subject matter of Examples 79-92 includes functionalities such as, wherein deactivation of the subset of hardware resources comprises: means for placing a deactivated portion of the hardware resources into at least a lower power mode or a no power mode, or reallocating the deactivated portion of the hardware resources for use in other functions within the compute circuitry.
In Example 94, the subject matter of Examples 72-93 includes functionalities such as, wherein the neural network management circuitry is configured to process a workload comprising any of image data, audio data, sensor data, time-series data, or network traffic data.
Example 95 is at least one machine-readable medium including instructions that, when executed by processing circuitry, cause the processing circuitry to perform operations to implement any of Examples 1-94.
Example 96 is an apparatus comprising means to implement any of Examples 1-94.
Example 97 is a system to implement any of Examples 1-94.
Example 98 is a method to implement any of Examples 1-94.
Example 99 is at least one machine-readable storage including machine-readable instructions, which when executed, cause a computer to implement a method or a process as claimed in any of Examples 1-94.
Example 100 is a computer program comprising instructions which, when the program is executed by a computer, cause the computer to carry out one or more operations according to at least one of Examples 1-94.
Example 101 is an apparatus comprising means to perform a method or a process as recited by at least one of Examples 1-94.
Example 102 is a computer storage medium that stores instructions for execution by one or more processors of a communication device, the instructions to cause the communication device to perform a method or a process as recited by at least one of Examples 1-94.

Additional examples of the presently described embodiments include the following non-limiting implementations. Each of the following non-limiting examples may stand on its own or may be combined in any permutation or combination with any one or more of the other examples provided below or throughout the present disclosure.

In broad strokes, the disclosed NN power management techniques and circuitry include the use of hardware-level adaptability to dynamically configure neural network processing circuitry for optimal power efficiency and computational precision. These techniques and circuitry leverage a neural network manageability engine to receive configuration parameters associated with the workload and selectively activate or deactivate subsets of hardware resources, such as multiplication-addition circuits (MACs) and input sub-registers, in real time. As illustrated in FIG. 8, the system can operate in a first resolution mode by enabling a first subset of hardware resources (e.g., a set of INT4 sub-registers and a first MAC) to perform coarse classification tasks, thereby minimizing power consumption during periods when only basic class-level detection is required. Upon detecting a trigger or completion of the coarse classification task, the manageability engine transitions the system to a second resolution mode by enabling an additional subset of hardware resources (e.g., a second MAC and additional sub-registers) to perform fine-grained classification, such as identifying sub-classes within a detected class. The disclosure further supports more than two resolution modes, including intermediate or appropriate resolution modes, allowing the system to dynamically adapt the level of detail and resource allocation to the complexity or importance of the data geometry being processed. FIG. 9 demonstrates a compact implementation in which a single MAC is reused across multiple cycles, allowing the system to achieve fine resolution by sequentially processing different portions of the input and weight data, thus reducing area and further optimizing power usage. The manageability engine can also control transitions between operational and power modes, including low-power, ultra-low power, and full-power states, based on workload status, telemetry, or external commands. These techniques and circuitry enable seamless, automatic, and flexible switching between different resolution and power modes, supporting energy efficiency and workload-adaptive operation across a wide range of data types and computing environments.

What is claimed is:

1. Processing circuitry, comprising:
compute circuitry, the compute circuitry comprising hardware resources to perform compute operations of a neural network configured in a computing platform, the hardware resources comprising at least one multiplication-addition circuit (MAC) and input registers; and
neural network management circuitry to:
selectively activate or deactivate a subset of the hardware resources of the compute circuitry based on a configuration parameter of a workload of the neural network;
configure the compute circuitry to operate in a first resolution mode by enabling a first plurality of input sub-registers of the input registers as a first subset of the hardware resources to perform a coarse classification task;
configure the compute circuitry to operate in a second resolution mode to perform a fine classification task by enabling a second plurality of input sub-registers of the input registers as a second subset of the hardware resources, based on an outcome of the coarse classification task; and
control transitions between the first resolution mode and the second resolution mode based on a completion status of the workload.

2. The processing circuitry of claim 1, wherein the neural network management circuitry is to:
determine the completion status of the workload based on at least one of: a quantization circuit of the compute circuitry detecting that the coarse classification task has produced a classification result, a sigmoid function circuit detecting that an accumulated sum exceeds a pre-configured threshold indicating a classification has occurred, or the neural network management circuitry detecting that coarse resolution processing has completed for at least a pre-configured portion of the workload.

3. The processing circuitry of claim 1, the at least one MAC comprising a first MAC and a second MAC, the first MAC coupled to the first plurality of input sub-registers, the second MAC coupled to the second plurality of input sub-registers, and wherein the neural network management circuitry is to:
configure the compute circuitry to operate in the first resolution mode by the first plurality of input sub-registers and activating the first MAC while deactivating the second MAC, and to configure the compute circuitry to operate in the second resolution mode by activating the second MAC and the second plurality of input sub-registers.

4. The processing circuitry of claim 3, wherein the first plurality of input sub-registers is exclusively allocated to the first MAC and the second plurality of input sub-registers exclusively allocated to the second MAC, such that the first plurality of input sub-registers provides input data and weight data to multiplier circuits of the first MAC and the second plurality of input sub-registers provides input data and weight data to multiplier circuits of the second MAC.

5. The processing circuitry of claim 3, wherein the neural network management circuitry is to:
configure the compute circuitry to operate in the second resolution mode by enabling the first plurality of input sub-registers of the input registers to be reused for the fine classification task in addition to the second plurality of input sub-registers, to perform the fine classification task.

6. The processing circuitry of claim 5, wherein the neural network management circuitry is to:
configure the compute circuitry to operate in the second resolution mode by reusing the first plurality of input sub-registers of the input registers for the fine classification task.

7. The processing circuitry of claim 6, the compute circuitry comprising:
a memory to store input data and weights for the neural network;
the first MAC comprising: a first set of input sub-registers, each configured to store 4 bits of data, to hold input data and weights fetched from the memory; a first pair of multiplier circuits to compute products of the input data and the weights from the first set of input sub-registers; a first set of result registers to store intermediate products from the first pair of multiplier circuits; and a first adder circuit to accumulate the intermediate products from the first set of result registers to produce a first accumulated sum;
the second MAC comprising: a second set of input sub-registers, each configured to store 4 bits of data, to hold input data and weights fetched from the memory; a second pair of multiplier circuits to compute products of the input data and the weights from the second set of input sub-registers; a second set of result registers to store intermediate products from the second pair of multiplier circuits; and a second adder circuit to accumulate the intermediate products from the second set of result registers to produce a second accumulated sum;
a sigmoid function circuit to apply a non-linear activation function to at least one of the first accumulated sum or the second accumulated sum; and
a quantization circuit to reduce a bit-width of an output of the sigmoid function circuit to produce a quantized output, the neural network management circuitry to selectively activate the first MAC and deactivate the second MAC during the first resolution mode to perform the coarse classification task using the first set of input sub-registers, and to activate the second MAC during the second resolution mode to perform the fine classification task using the second set of input sub-registers.

8. The processing circuitry of claim 1, wherein the neural network management circuitry is to:
generate the configuration parameter based on a quantized output of the neural network indicating a detection of a specific class.

9. The processing circuitry of claim 1, wherein the configuration parameter generated by the neural network management circuitry is based on at least one of: a quantized output of the neural network, a sigmoid function result that exceeds a pre-configured threshold, telemetry data indicating resource utilization of the hardware resources, or an external command received via a management software stack of the computing platform.

10. The processing circuitry of claim 8, wherein the hardware resources comprise a plurality of multiplication-addition circuits (MACs) and a plurality of input sub-registers, each input sub-register configured to store less than 8 bits of data, and wherein the neural network management circuitry is to:
deactivate at least one MAC of the plurality of MACs during the first resolution mode, and activate the at least one MAC during the second resolution mode.

11. The processing circuitry of claim 10, wherein the neural network management circuitry is to:
receive telemetry data from the compute circuitry, the telemetry data indicating at least a utilization rate of the hardware resources; and
selectively activate or deactivate the subset of the hardware resources via the configuration parameter, based on the utilization rate of the hardware resources.

12. The processing circuitry of claim 11, wherein the neural network management circuitry is to:
perform an automatic wake-up by transitioning from the first resolution mode to the second resolution mode in response to a trigger condition detected by the neural network.

13. The processing circuitry of claim 12, wherein the trigger condition is based on at least one of:
the completion status of the workload; and
the telemetry data exceeding a pre-configured value.

14. The processing circuitry of claim 13, wherein the hardware resources comprise a plurality of result registers, and wherein the neural network management circuitry is to:
selectively activate or deactivate the plurality of result registers based on the configuration parameter;
selectively activate or deactivate sub-registers of the plurality of result registers based on the configuration parameter;
control a sigmoid function circuit to apply a non-linear activation function to an accumulated sum in both the first and second resolution modes; and
operate the compute circuitry based on powering down or disconnecting at least a portion of the hardware resources during the first resolution mode.

15. The processing circuitry of claim 1, wherein the workload comprises image data that includes a class and a sub-class, and wherein:
to perform the coarse classification task, the neural network management circuitry is to:
configure the first subset of the hardware resources to detect the class of the image data; and
to perform the fine classification task, the neural network management circuitry is to:
configure a second subset of the hardware resources to detect the sub-class of the image data.

16. An apparatus comprising:
means for selectively activating or deactivating a subset of hardware resources of compute circuitry based on a configuration parameter of a workload of a neural network, the hardware resources comprising at least one multiplication-addition circuit (MAC) and input registers;
means for configuring the compute circuitry to operate in a first resolution mode by enabling a first plurality of input sub-registers of the input registers as a first subset of the hardware resources to perform a coarse classification task;
means for configuring the compute circuitry to operate in a second resolution mode to perform a fine classification task by enabling a second plurality of input sub-registers of the input registers as a second subset of the hardware resources, based on an outcome of the coarse classification task; and
means for controlling transitions between the first resolution mode and the second resolution mode based on a completion status of the workload.

17. The apparatus of claim 16, wherein the at least one MAC comprises a first MAC and a second MAC, wherein the first MAC is coupled to the first plurality of input sub-registers, and wherein the second MAC is coupled to the second plurality of input sub-registers, and further comprising:
means for activating the first MAC while deactivating the second MAC during the first resolution mode; and
means for activating the second MAC during the second resolution mode.

18. The apparatus of claim 17, further comprising:
means for configuring the compute circuitry to operate in the second resolution mode by reusing the first plurality of input sub-registers of the input registers to perform the fine classification task.

19. The apparatus of claim 18, further comprising:
means for configuring the compute circuitry to operate in the second resolution mode by reusing the first plurality of input sub-registers of the input registers for the fine classification task.

20. The apparatus of claim 16, further comprising:
means for generating the configuration parameter based on a quantized output of the neural network indicating a detection of a specific class.

21. At least one non-transitory machine-readable medium comprising instructions stored thereon, which, when executed by one or more processors of a computing device of a neural network, cause the computing device to:
selectively activate or deactivate a subset of hardware resources of compute circuitry based on a configuration parameter of a workload of the neural network, the hardware resources comprising at least one multiplication-addition circuit (MAC) and input registers coupled to the at least one MAC;
configure the compute circuitry to operate in a first resolution mode by enabling a first plurality of input sub-registers of the input registers as a first subset of the hardware resources to perform a coarse classification task;
configure the compute circuitry to operate in a second resolution mode to perform a fine classification task by enabling a second plurality of input sub-registers of the input registers as a second subset of the hardware resources, based on an outcome of the coarse classification task; and
control transitions between the first resolution mode and the second resolution mode based on a completion status of the workload.

22. The at least one non-transitory machine-readable medium of claim 21, wherein the at least one MAC comprises a first MAC and a second MAC, the first MAC coupled to the first plurality of input sub-registers, the second MAC coupled to the second plurality of input sub-registers, and the instructions further causing the computing device to:
activate the first MAC while deactivating the second MAC during the first resolution mode; and
activate the second MAC during the second resolution mode.

23. The at least one non-transitory machine-readable medium of claim 22, the instructions further causing the computing device to:
configure the compute circuitry to operate in the second resolution mode by reusing the first plurality of input sub-registers of the input registers to perform the fine classification task; and
generate the configuration parameter based on a quantized output of the neural network indicating a detection of a specific class.

24. The at least one non-transitory machine-readable medium of claim 21, wherein the hardware resources comprise a plurality of multiplication-addition circuits (MACs), and the instructions further cause the computing device to:
deactivate at least one MAC of the plurality of MACs during the first resolution mode and activate the at least one MAC during the second resolution mode;
receive telemetry data from the compute circuitry, the telemetry data indicating at least a utilization rate of the hardware resources;
selectively activate or deactivate the subset of the hardware resources via the configuration parameter, based on the utilization rate of the hardware resources; and
perform an automatic wake-up by transitioning from the first resolution mode to the second resolution mode in response to a trigger condition detected by the neural network.

25. The at least one non-transitory machine-readable medium of claim 24, wherein the trigger condition is based on at least one of: the completion status of the workload;
and the telemetry data exceeding a pre-configured value.
